(19) United States
(12) Patent Application Publication
(10) Pub. No.: US 2019/0019148 A1
(43) Pub. Date: Jan. 17, 2019

(54) AUTOMATED NEGOTIATOR GOVERNED BY DATA SCIENCE

(71) Applicant: LevaData Inc., Sunnyvale, CA (US)

(72) Inventors: Srinivasan Kumar, Sunnyvale, CA (US); Aditya Murthi, Fremont, CA (US); Sudip Das, San Jose, CA (US); Saru Mehta, Pleasanton, CA (US); Vitaliy Khizhnichenko, Sunnyvale, CA (US); Bhargav Chereddy, Walnut Creek, CA (US)

(73) Assignee: LevaData Inc., Sunnyvale, CA (US)

(21) Appl. No.: 16/037,887

(22) Filed: Jul. 17, 2018

Related U.S. Application Data
(60) Provisional application No. 62/533,498, filed on Jul. 17, 2017.

(51) Int. Cl. G06Q 10/08

(52) U.S. Cl. CPC G06Q 10/08345; G06Q 10/0875; G06Q 10/0831

(57) ABSTRACT

A system, method and device for enabling improved negotiations in a supply chain between parties to the supply chain is disclosed. The system, method and device includes a communication device for receiving interactions and transactions regarding the parties involved in the supply chain, a processor for determining factors that aid in the leverage of negotiations between the parties involved in the supply chain by analyzing the received interactions and transaction, and a transmitter for transmitting the identification of the determined factors and the respective values based on the entity using the device.

### CROSS REFERENCE TO RELATED APPLICATION

This application claims the benefit of U.S. provisional application No. 62/533,498 filed Jul. 17, 2017 entitled AUTOMATED NEGOTIATOR GOVERNED BY DATA SCIENCE, which is incorporated by reference as if fully set forth.

### FIELD OF INVENTION

The present invention is directed toward negotiation using data science, and more particularly, to an automated negotiator governed by data science.

### SUMMARY

A system, method and device for enabling improved negotiations in a supply chain between parties to the supply chain are disclosed. The system, method and device include a communication device for receiving interactions and transactions regarding the parties involved in the supply chain, a processor for determining factors that aid in the leverage of negotiations between the parties involved in the supply chain by analyzing the received interactions and transactions, and a transmitter for transmitting the identification of the determined factors and the respective values based on the entity using the device.

The system, method and device include a plurality of parts that together are assembled into an output product of the supply chain, a first supplier for supplying a first of the plurality of parts, a second supplier for supplying the first of the plurality of parts, and a device for enabling improved negotiations in the supply chain between an OEM and the first supplier and between the OEM and the second supplier, the device including a communication device for receiving interactions and transactions regarding the OEM, the first supplier and the second supplier regarding the first plurality of parts, a processor for determining factors that aid in the leverage of negotiations between the OEM and either of the first supplier or the second supplier by analyzing the received interactions and transaction, and a transmitter for transmitting the identification of the determined factors and the respective values to the OEM.

### BRIEF DESCRIPTION OF THE DRAWINGS

A more detailed understanding may be had from the following description, given by way of example in conjunction with the accompanying drawings wherein:

FIG. 1 illustrates a system for enabling improved negotiations in a supply chain between parties to the supply chain;

FIG. 2 illustrates a method for enabling improved negotiations in a supply chain between parties to the supply chain and may operate within the system of FIG. 1;

FIG. 3 is an illustration of a computing system that may be utilized to implement one or more features described herein as performed by the controller;

FIG. 4 illustrates an example supply chain utilized in the making of a computer;

FIG. 5 illustrates an example contract manufacturing scenario where suppliers provide components to contract manufacturers who make and ship to OEM's;

FIG. 6 illustrates the interrelationship of elements utilized to achieve this objective;

FIG. 7 illustrates a detailed prediction methodology;

FIG. 8 illustrates a regression framework;

FIG. 9 illustrates an example plot of price represented as a probability distribution;

FIG. 10 illustrates the pipeline used to generate component cost predictions;

FIG. 11 illustrates the predictions generated by the PRM of FIG. 10;

FIG. 12 illustrates a depiction of a mixed linear programming solver to obtain the optimal split of business between component suppliers;

FIG. 13 illustrates an example of classification;

FIG. 14 illustrates a screen depiction of the screen of the system of FIG. 1;

FIG. 15 illustrates a flow diagram providing modules for a chatbot for interacting within the system of FIG. 1; and

FIG. 16 illustrates a screen depiction of a screen of the system of FIG. 1.

### DETAILED DESCRIPTION

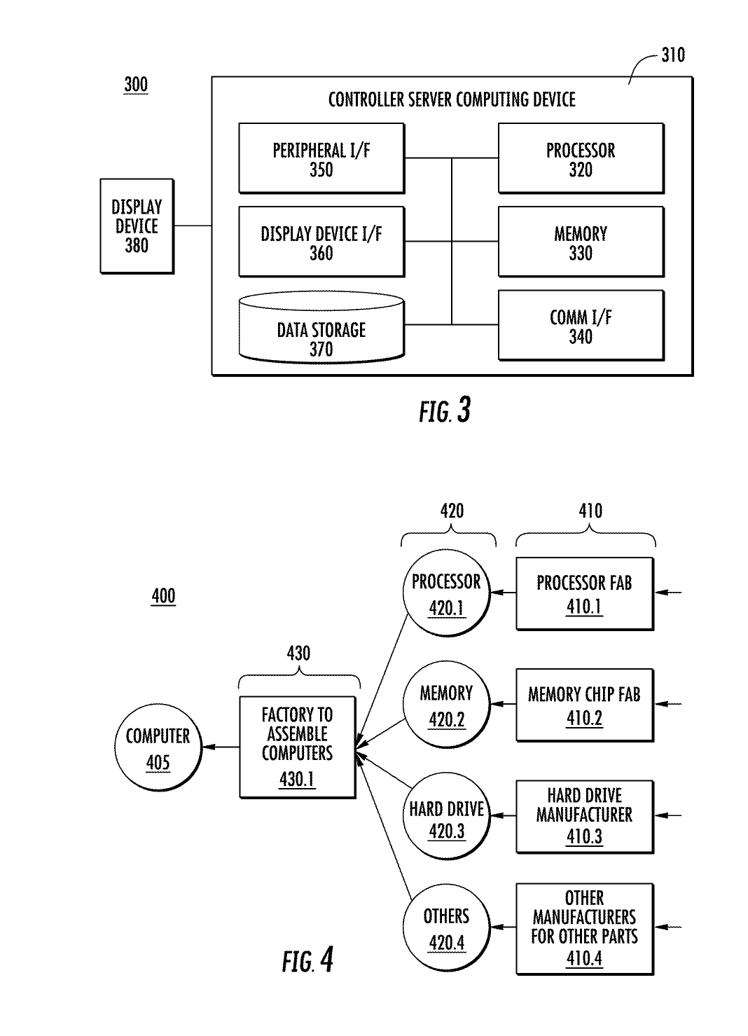

The present invention provides an automated negotiator that is governed by data science techniques. The automated negotiator analyzes traffic on the network between the machine used by parties to a transaction or series of transactions and enables improved negotiating by determining factors that aid in the leverage of the negotiations between these networked parties. These factors are determined by the features described below and applied to the system of computing devices, which computing devices are defined in FIG. 3 below.

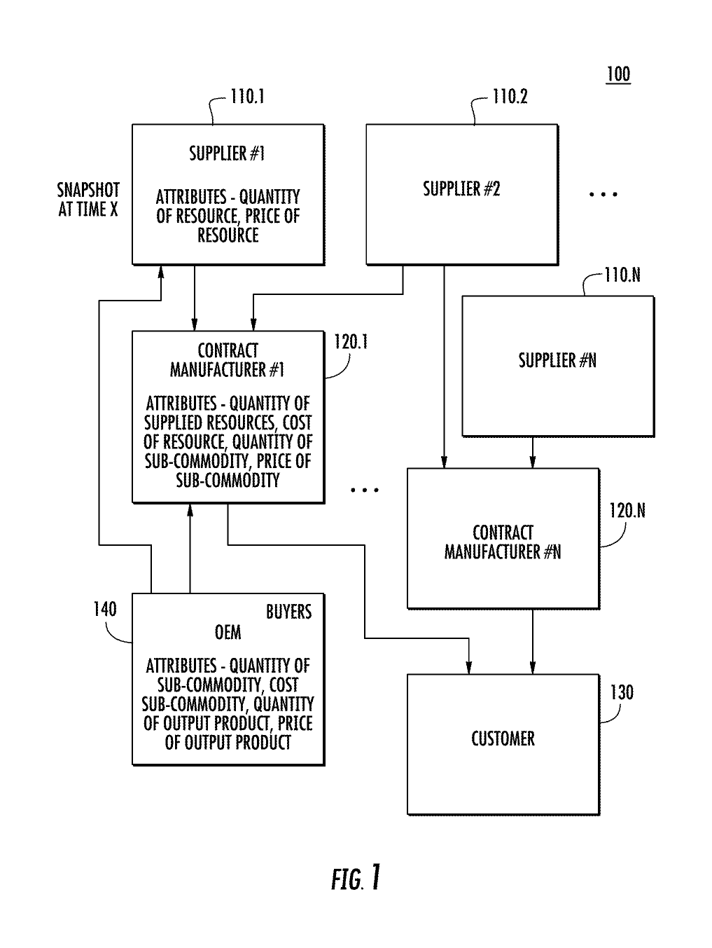

FIG. 1 illustrates a system 100 for enabling improved negotiations in a supply chain between parties to the supply chain. System 100 includes one or more suppliers 110 that supply one or more contract manufacturers 120. The contract manufacturers 120 provide products to customers 130. The product is presented on behalf of the OEM 140. The one or more suppliers 110 may be individually identified as supplier 110.1, supplier 110.2, . . . , supplier 110.N. Contract manufacturer 120 may be similarly individually identified as contract manufacturers 120.1, . . . , contract manufacturers 120.N. Each of suppliers 110, contract manufacturers 120, customer 130 and OEM 140 may interact with each other and system 100 generally using or via a controller server computing device, described in greater detail with respect to FIG. 3 below, that includes a processor, memory, communication interface and data storage for capturing information with system 100.

The one or more suppliers 110 receives as an input a quantity of a resource for a set price of the resource. The quantity of the resource can be delivered by another layer of supplier, or may be mined, or otherwise acquired. The price of the resource may include as a basis the cost of acquiring the resource either by purchase or the cost to extract the resource. The supplier 110 then supplies this resource to the contract manufacturer 120. For example, the resource may be a precious metal used in making processors. The supplier 110 may mine the metal from the earth and supply it to the contract manufacturer 120.

The one or more contract manufacturers 120 may receive as inputs a quantity of resources from one more suppliers 110. These resources may be acquired for a price. The one or more contract manufacturers 120 may use the resource in manufacturing a component. Once manufactured the contract manufacturer 120 has a quantity of the component available at a price. In the example, the contract manufacturer 120 may receive a metal from the supplier and turn this metal into a computer processor. The computer processor may then be delivered downstream in the supply chain to another contract manufacturer operating at another level, such as an assembler, where the processor is assembled with other materials into a laptop computer. This laptop computer may then be delivered to a customer 130.

There may be a set amount of customer 130 which provide the demand for the product being produced. The product may be produced at the behest of the OEM 140 and using the branding of the OEM. For example, the laptop may be branded APPLE and the OEM 140 is then APPLE.

In this configuration, the supply chain may include many vertical levels, even though only two are shown in FIG. 1 and several discussed herein. In addition, the horizontal width of the supply chain may be greater that then one-dimensional discussion in the present discussion. For example, there may be a vertical in the supply chain for every part within the laptop, for example.

The OEM 140 may operate to define the parameters of the supply chain reaching the customer 130. In so doing, the OEM may provide a buyer that negotiates with each of the members of the supply chain to ensure operation of the supply chain in defined parameters in delivering the product to the customer 130.

To enhance the understanding of the enclosed application the following terminology is used.

Product is the finished good that is sold to the downstream entity in the supply chain.

Bill of material (BOM) describes the input component and the output item. The output item may be the finished good (product), but may also be sub-assemblies, in which case the bill of materials becomes a tree structure. The term is usually used for a single level transformation but sometimes a tree of transformations over multiple levels.

Original equipment manufacturer (OEM) is the owner of the label of the shipped product. This is a term used in the context of contract manufacturing. An example of OEM may be Apple.

Contract manufacturer (CM) is the manufacturer of the product on behalf of the OEM. An example of a CM may be FoxConn who manufactures for Apple. After being contracted, the OEM provides the forecasts and orders for finished products to the CM. The CM orders the components from the suppliers at unit prices negotiated by the CM with the suppliers, manufactures the product using these components, ships the finished products to the facilities specified by the OEM, and of course bills the OEM.

The entire bill of materials (which may contain over a thousand components) may not be negotiated between the OEM and the suppliers. The CM may have experience and therefore “manage” portions of the bill of material, in that the CM may negotiate with the supplier independently from the OEM. The OEM in this case may have visibility no more detailed than what the CM puts together. For a simple illustrative example, if the CM is making cars, if the CM manages the wheels completely, the OEM may not have visibility to the tires. The OEM may only see the wheel as if it were a bought component. For these, the CM is also called the original design manufacturer (ODM).

Customer part number (CPN) is the identifier the customer uses to refer to an item. A single CPN may refer to multiple items from different suppliers.

Manufacturer Part Number (MPN) is the identifier that a manufacturer (who is often the supplier) uses to refer to an item. A single CPN may correspond to multiple MPN's, as stated for the CPN's.

Commodity is a high-level grouping of CPN's. Sub-commodity is a lower level grouping of CPN's under a commodity. Commodities and sub-commodities may also enable the “network effect”, where there are many suppliers for an item, the optimal price may be lower than it would be if there are only a few suppliers for an item.

Time period is the time for which forecasting is performed. Forecasting is done for specific time periods. Therefore, along with MPN, the time period defines the key for the historical data, and of course, the forecast.

Supplier supplies the MPN to the customer. Frequently, it is synonymous with the manufacturer.

Manufacturer creates the item that goes into the product. A manufacturer does not have to be the supplier, but may be.

Spend is the term used to denote the money expended. This may be by item, by supplier or by any other faceting that becomes convenient information for negotiation.

Buyer is the negotiator for a set of customer part numbers. These form a natural set that are typically part of a sub commodity or a commodity. The buyer negotiates the price and other terms with the list of prospective suppliers, and then awards the business for a particular period (typically, the subsequent quarter) to a subset of suppliers from those who respond to the buyer's request for a quote (RFQ) from the OEM. The buyer also awards the business in different proportions to each of these suppliers. The buyer picks the suppliers and the proportion of business awarded to each guided by considerations of the total spend and/or unit prices, but also strategic considerations such as long-term relationships, and considerations like risk of being with a single supplier.

Total addressable market (TAM) is the total amount of business a supplier may get from the buyer. If multiple suppliers supply a particular CPN, the total addressable market is the total amount paid by the buyer for that CPN.

RFQ is the means by which the OEM kicks off communications with the supplier or CM in order to come to an agreement with the supplier(s) to supply specific quantities of MPN's at specific unit prices.

Award is the award of a certain amount of business (e.g. a certain amount of spend) to a certain supplier. This is the final outcome of a successful RFQ process. An unsuccessful outcome may mean that the RFQ is simply closed.

Compounded annual growth rate (CAGR) is the effective growth rate of a sequence of quantities. It is the geometric mean of the ratios of successive quantities. That is, it is the ratio of that geometric series that has the same number of quantities with the first and last terms of the two series being identical.

New product introduction (NPI) is a program to introduce new products. These typically need planning and forethought to ensure that the products are launched smoothly.

Business unit (BU) is a part of a business that is treated as if it were a separate business in that it is treated as a profit-and-loss entity.

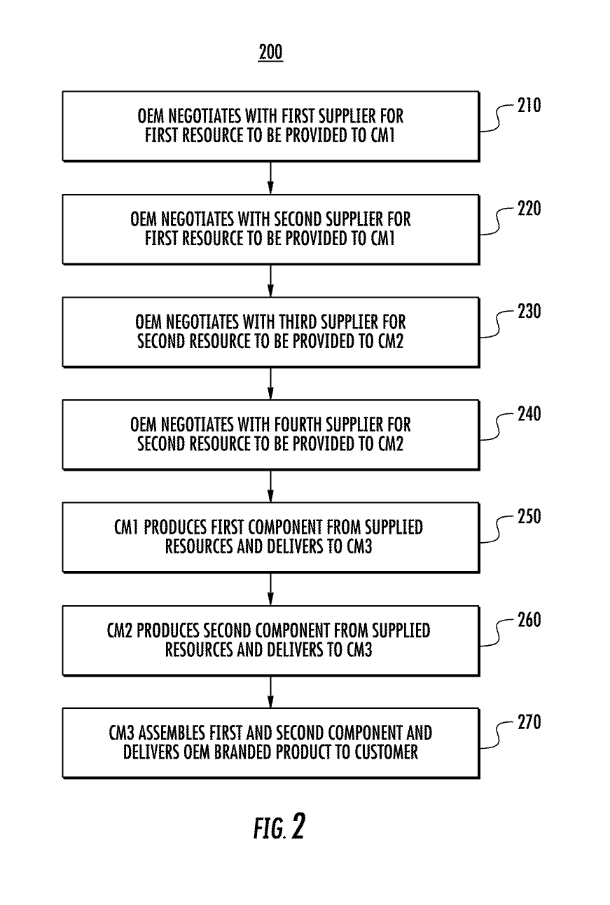

FIG. 2 illustrates a method 200 for enabling improved negotiations in a supply chain between parties to the supply chain. Method 200 may operate within the system of FIG. 1. In method 200, OEM negotiates with a first supplier for a first resource to be provided to a first contract manufacturer at step 210. At step 220, the OEM negotiates with a second supplier for a first resource to be provided to a first contract manufacturer. The OEM also negotiates with a third suppler for a second resource to be provided to the second contract manufacturer at step 230. At step 240, the OEM negotiates with a fourth supplier for a second resource to be provided to the second contract manufacturer. At step 250, the first contract manufacturer produces a first component from the supplier resources and delivers to a third contract manufacturers under parameters negotiated by the OEM. At step 260, the second contract manufacturer produces a second component from the supplier resources and delivers to a third contract manufacturers under parameters negotiated by the OEM. At step 270, the third contract manufacturer assembles first and second component and delivers an OEM branded product to the customer under parameters negotiated by the OEM.

FIG. 3 is an illustration of a computing system 300 that may be utilized in the present invention. The system 300 includes an example controller server computing device 310 that may be used to implement one or more features described herein as performed by the controller. The controller server computing device 310 may include a processor 320, a memory device 330, a communication interface 340, a peripheral device interface 350, a display device interface 360, and a data storage device 370. System 300 includes a display device 380 coupled to or included within the computing device 310. This computing system 300 may be located at any of the parties within system 100, perform any of the steps in method 200, and may collect data associated with or used within system 100 or in method 200.

As used herein, the term “processor” 320 refers to a device such as a single- or multi-core processor, a special purpose processor, a conventional processor, a Graphics Processing Unit (GPU), a digital signal processor (DSP), a plurality of microprocessors, one or more microprocessors in association with a DSP core, a controller, a microcontroller, one or more ASICs, one or more Field Programmable Gate Array (FPGA) circuits, any other type of integrated circuit (IC), a system-on-a-chip (SOC), a state machine, or a similar type of device. Processor 320 may be or include any one or several of these devices.

The memory device 330 may be or include a device such as a Random Access Memory (RAM), Dynamic RAM (D-RAM), Static RAM (S-RAM), other RAM or a flash memory. Further, memory device 330 may be a device using a computer-readable medium.

The data storage device 370 may be or include a hard disk, a magneto-optical medium, a solid-state drive (SSD), an optical medium such as a compact disk (CD) read only memory (ROM) (CD-ROM), a digital versatile disk (DVDs), or Blu-Ray disc (BD), or other type of device for electronic data storage. Further, data storage device 370 may be a device using a computer-readable medium. As used herein, the term “computer-readable medium” refers to a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVDs, or BD, or other type of device for electronic data storage.

The communication interface 340 may be, for example, a communications port, a wired transceiver, a wireless transceiver, and/or a network card. The communication interface 340 may be capable of communicating using technologies such as technology, wide area network (WAN) technology, SD-WAN technology, Ethernet, Gigabit Ethernet, fiber optics, microwave, xDSL (Digital Subscriber Line), Institute of Electrical and Electronics Engineers (IEEE) 802.11 technology, Wireless Local Area Network (WLAN) technology, wireless cellular technology, or any other appropriate technology.

The peripheral device 350 interface is configured to communicate with one or more peripheral devices 350. The peripheral device interface 350 operates using a technology such as Universal Serial Bus (USB), PS/2, Bluetooth, infrared, serial port, parallel port, FireWire and/or other appropriate technology. The peripheral device interface 350 may, for example, receive input data from an input device such as a keyboard, a keypad, a mouse, a trackball, a touch screen, a touch pad, a stylus pad, a detector, a microphone, a biometric scanner, or other device. The peripheral device interface 350 may provide the input data to the processor. The peripheral device interface 350 may also, for example, provide output data, received from the processor 320, to output devices (not shown) such as a speaker, a printer, a haptic feedback device, one or more lights, or other device. Further, an input driver (not shown) may communicate with the processor 320, peripheral device interface 350 and the input devices, and permit the processor 320 to receive input from the input devices. In addition, an output driver may communicate with the processor 320, peripheral device interface 350 and the output devices, and permit the processor 320 to provide output to the output devices. One of ordinary skill in the art will understand that the input driver and the output driver may or may not be used, and that the controller server computing device 310 may operate in the same manner or similar manner if the input driver, the output driver or both are not present.

The display device interface 360 may be an interface configured to communicate data to display device 380. The display device 380 may be, for example, a monitor or television display, a plasma display, a liquid crystal display (LCD), or a display based on a technology such as front or rear projection, light emitting diodes (LEDs), organic LEDs (OLEDs), or Digital Light Processing (DLP). The display device interface 360 may operate using technology such as Video Graphics Array (VGA), Super VGA (S-VGA), Digital Visual Interface (DVI), High-Definition Multimedia Interface (HDMI), Super Extended Graphics Array (SXGA), Quad Extended Graphics Array (QXGA), or other appropriate technology. The display device interface 360 may communicate display data from the processor 320 to the display device 380 for display by the display device 380. Also, the display device 380 may connect with speakers and may produce sounds based on data from the processor 320. As shown in FIG. 3, the display device 380 may be external to the computing device 310 and coupled to the computing device 310 via the display device interface 360. Alternatively, the display device 380 may be included in the computing device 310. An instance of the computing device 310 of FIG. 3 may be configured to perform any feature or any combination of features of the system 100 and method 200 described herein as performed by the controller.

As will be described in detail below, the present invention provides an automated negotiator that is governed by data science techniques. The automated negotiator analyzes traffic on the network between the computing devices 310 used by parties of system 100 involved a transaction or series of transactions and enables improved negotiating by determining factors that aid in the leverage of the negotiations between these networked parties. These factors are determined by the features described below and applied to the system 100 of computing devices 310.

Each of the entities within the system 100 may interact using a device such as the device 300 depicted in FIG. 3. This interaction may occur across the internet or via any other communication channel. Once the values for the negotiation are determined by the negotiator, various entities may be informed of the respective negotiating information and advantages including price and leverage items, as will be described. The use of the device 300 of FIG. 3 is omitted from the discussion of the various interactions in order for the complexity of the invention to be reduced and provide for ease of understanding the invention and relationship between the parties. These relationships and interactions may be performed using the device 300 of FIG. 3, as would be understood, across a communication means.

FIG. 4 illustrates an example supply chain 400 utilized in the making of a computer 405. This supply chain 400 provides a more detailed example of that depicted in FIG. 1 above. Generally, supply chains are organizations of entities and processes that together result in raw materials being transformed into economic goods for end consumers. Every physical artifact that people are familiar with is produced in a supply chain. Examples of supply chain processes are buy, make, store, transport and sell. There may be many organizations (belonging to different companies) in the journey from raw materials to finished economic goods. Supply chains may operate differently in terms of business processes depending on what they process, the level of maturity of the industry and other accidental economic conditions.

As shown in FIG. 4, four example fabrications 410 are used to produce four parts 420 in the computer 405. While this supply chain 400 is depicted with a single end product with four input products formulated via raw materials, supply chains may have additional levels of processes and sub-processes, for example and may have any number of products being incorporated at each or any stage of the supply chain. As would be understood to those possessing an ordinary skill in the art, these four fabrications 410 and parts 420 are just example, as there are hundreds or thousands of parts within the computer 405, each part being produced in its own fabrication 420 using its own set of parts and processes.

The specific example fabrications detailed in FIG. 4 include a processor 420.1 and its fabrication 410.1, a memory chip 420.2 and its fabrication 410.2, a hard drive 420.3 and its fabrication 410.3, and other parts 420.4 and their respective fabrications 410.4. Each of the respective parts 420 is then accumulated in a factory or even a series of factories if assembly 430 is performed piecemeal, to be ultimately assembled 430.1 into a computer 405. The output of the supply chain 400 is the product—in this case, a computer 405.

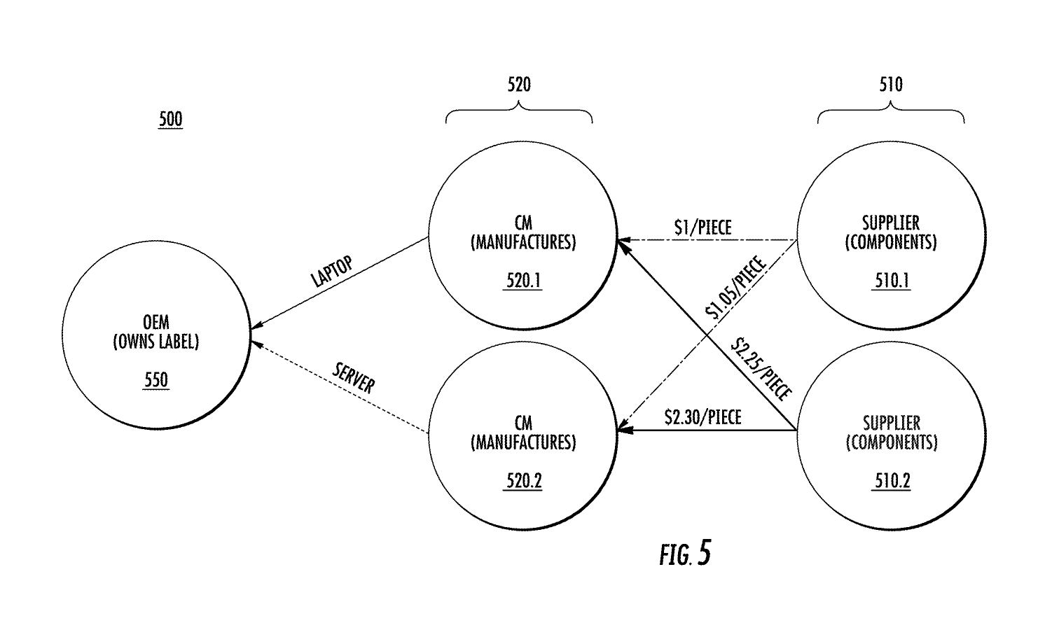

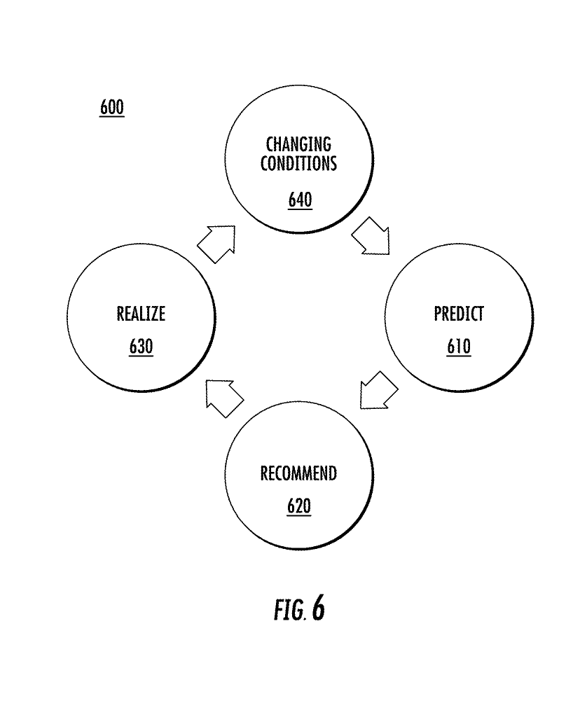

FIG. 5 illustrates an example contract manufacturing scenario 500 where suppliers provide components 510 to contract manufacturers 520 who make and ship to OEM's 550. Generally, the concept of contract manufacturing is prevalent in supply chains Contract manufacturing exists wherever it makes sense to separate out design from manufacturing for efficiencies and economies resulting from consolidation. Contract Manufacturers (CM) 520 manufacture for someone else. This is common in the manufacture of common items like laptops and phones, for example. The label owner often called the OEM 550, contracts with the CM 520, and often contracts with the component suppliers 510 for components that the CM 520 assembles together. For example, the phone label owner may contract for the glass covering, the processor and other items. The OEM 550 also provides the CM 520 the forecasts and the customer orders for the finished products (not the components whose price the OEM 550 negotiates with the component suppliers 510, but the finished products) and the CM 520 manufactures to these forecasts, and orders and ships to facilities and addresses specified by the OEM 550.

In the setup of the above arrangement for (a group of) products, the OEM 550 has to negotiate with the CM 520 as well as component suppliers 510. These negotiations are typically for large volumes, and therefore, slight concessions in unit prices may mean the gain or loss of very significant amounts of dollars. For example, if there are ten million processors to be negotiated, a price concession of ten dollars a unit may result in a gain or loss of a hundred million dollars. This is why the negotiation becomes extremely important.

Usually, it is in the interest of the OEM 550, the CM(s) 520 and the component supplier(s) 510 to come to an agreement. The OEM 550 needs the CM 520 to make the product and the component supplier 510 to provide the component before the OEM's 550 competitor brings a competing product to market. The CM 520 needs the OEM 550 because the CM 520 has production capacity that is idling if not used, and the CM's 520, owing to the nature of the value provided by the CMs 520, typically run on razor-thin margins. The component supplier 510 may find it profitable to have the components “designed into” the OEM's 550 product because with future versions, it may mean a very long lasting guaranteed business for the component supplier 510. Therefore, while the negotiations may get intense, it is usually in each party's interest to come to an agreement and begin the supplying, the manufacturing and the selling.

In FIG. 5, there is a depicted contract manufacturing scenario 500 of the OEM 550, CM 520 and component supplier 510. In this example, there are two component suppliers 510, depicted individually as component supplier 510.1, 510.2, and two CMs 520, depicted individually as CM 520.1, 520.2, that ultimately produce for the OEM 550. A first component supplier 510.1 sells to a first CM 520.1 for $1/piece and to a second CM 520.2 for $1.05/piece. A second component supplier 510.2 sells to the first CM 520.1 for $2.25/piece and to the second CM 520.2 for $2.30/piece. This scenario 500 allows for a determination of the number of pieces from the first component supplier 510.1 and the second component supplier 510.2 provided to each of the first CM 520.1 and second CM 520.2. The first CM 520.1 delivers laptops for the OEM 550 and the second CM 520.2 delivers servers for the OEM 550.

For every time period, such as a business quarter which is approximately 13 weeks, the OEM 550 negotiates with the component suppliers 510 for a set of components from a manufacturer, identified by MPNs, the components being related to a set of components, identified by CPNs, and awards certain percentages of the component needed and the OEM 550 to spend with specific component suppliers 510 after having determined the unit prices with each component supplier 510 for each of the components. The OEM 550 utilizes the total price across component suppliers 510 for the component and the unit price from the different component suppliers 510. The objective is to enable the OEM 510 to minimize the total price for the totality of components.

FIG. 6 illustrates the interrelationship of elements 600 utilized to achieve this objective. These elements include prediction 610, recommendation 620, realization 630 and changing conditions 640. Prediction 610 flows to recommendation 620 which flows to realization 630 and to changing conditions 640.

Prediction 610 is designed to predict the unit prices of the components in future time periods. Prediction 610 utilizes the past prices of that component, the groupings of similar commodities and sub-commodities, the specific raw materials that may affect prices of the components, and other price affecting conditions, such as economic factors such as foreign exchange and economic indices like GDP of a country that hosts manufacturers/suppliers, for example. That is, component parts that fall under a specific sub-commodity/commodity are grouped together in order to predict the associated component unit costs from overall sub-commodity/commodity price trends. Prediction 610 may depend on the actual quantities of that component or other related components in commerce. Prediction 610 enables the OEM to negotiate, and the more reasoned the predicted unit price, the better the OEM can perform in the negotiation.

Further, having a good prediction of all future prices enables the OEM to be able to optimally structure deals with the CM, using the volatility in the future price to provide an alert for structuring longer term price stability. For example, if the expected volatility is high, the OEM may be justified in paying a higher price to lock it in for the longer term, even if the current price is low.

Recommendation 620 is designed, based on the responses of the component suppliers to the RFQ, how much of the spend to award to each of possibly multiple component suppliers, and also what unit price to demand of each of the potential component suppliers. Optimization techniques may be used, since the recommendation 620 is fundamentally one of choice among alternatives, and each alternative has implications on total spend.

Optimization has three aspects involved which are the decision variables, an objective function and constraints. In one example where the decision variables are whether each component supplier is chosen or not, the quantities ordered from each chosen component supplier, the prices are fixed, and the sum of the products of these for each item is the objective function, and the constraints relate to the share of business bands with each component supplier, etc. Other constraints like the minimum and maximum number of component suppliers may be added. It may be seen that the variables are either in R+ or in {0, 1}, and that the constraints are all linear.

As an example, the different component suppliers may return with different offers in terms of prices and potentially, price breaks with quantities. The user may use that to provisionally assign business splits to each component supplier. For some components, there may be only one component supplier. In that case, the buyer has no choice of splits and simply has to buy from this one component supplier, as well as ask each component supplier for more specific concessions, offering increased business in the negotiated period, or future periods.

Alternatively, the component suppliers' quantities may be provisionally decided and the buyer may want to demand lowered prices from specific component suppliers. An optimization may be performed, beyond a human's natural ability, using suitable optimization algorithms.

Realization 630 makes a sequence of demands of the component suppliers to get to the desired outcome. Deep learning techniques may be utilized to create better models of the component suppliers and deciding demands, anticipating counter-demands and responses to those demands, with the objective that these sequences of demands constantly better the buyer's position, without the component supplier walking away. A determination of the price of each item may be realized and the extent of confidence in the price predicted is also necessary in order to be able to make decisions.

The following are the different techniques used for prediction of unit prices. Depending on the number of data points available, some techniques may be more accurate than others and the techniques that are most suited to those data points may be used. Additionally, the information may be richer than simply tuples of items, quantities and dates. Examples of such information would be why a certain technique was chosen, what regression variables if any were used, etc.

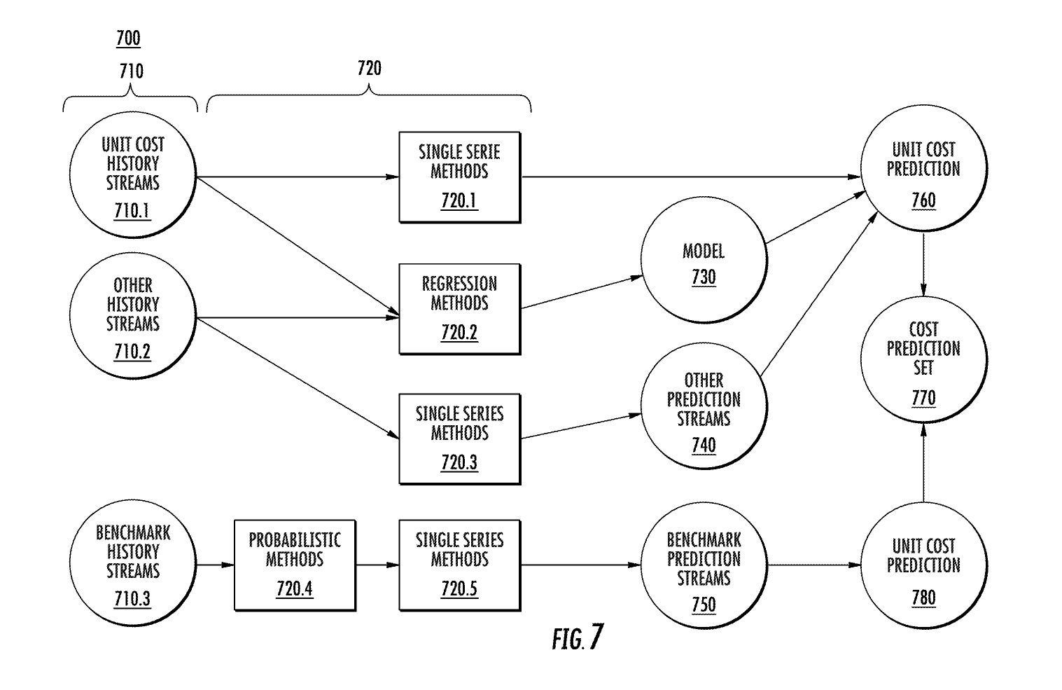

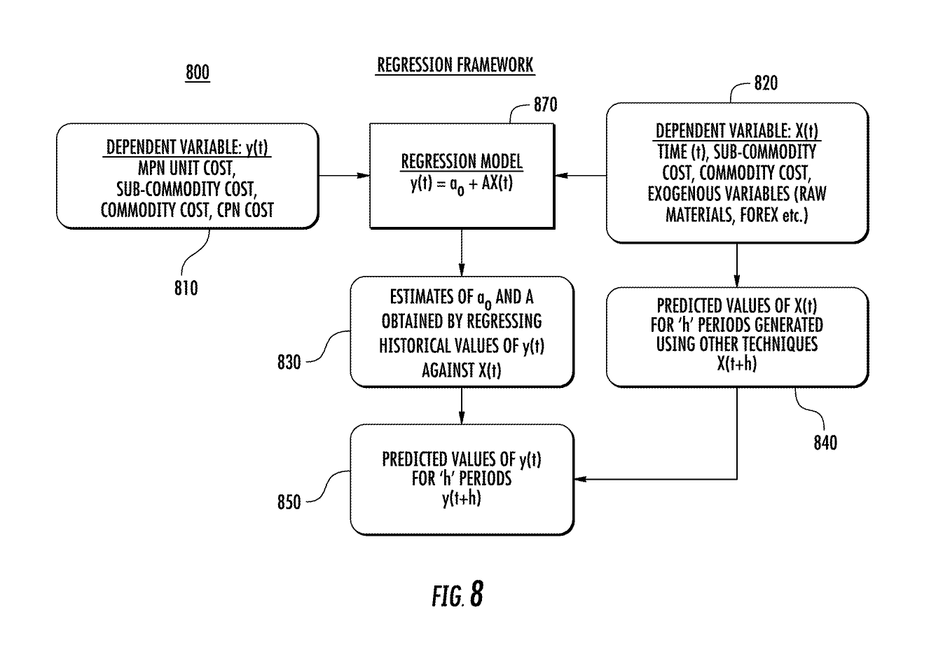

FIG. 7 illustrates a detailed prediction methodology 700. Simple and rapid techniques including single series methods may be used. Prediction methodology 700 attempts to get an accurate prediction in a timely fashion. For example, a prediction that is performed on-demand or real-time. Alternatively, offline methods may be employed. The data may be fit using simple approaches, such as benchmarking. The fit data may be evaluated using standard metrics. More sophisticated data modeling techniques may also be utilized. Techniques may include ensemble forecasting methods that combine forecasts from all individual single-series and probabilistic models. Another technique may be multi-variable regression that relies on correlations between the prices of component parts that belong to a certain sub-commodity or commodity grouping to predict future prices of individual component parts that fall into these hierarchical groupings. The purely data-driven or extrapolation based approaches used are described below.

In FIG. 7, there is shown a series of pathways representing prediction within the prediction methodology 700 that ultimately influence the unit cost prediction 760 and cost prediction set 770. Benchmarks may be harnessed and reduced using probabilistic methodologies leading the single series methods to provide benchmark prediction streams 750. These streams 710.3 provide the unit cost prediction 780 that is reduced to a cost prediction set 770. Similarly, unit cost history 720.1 may lead the single series methods 720.1 to provide unit cost prediction 760 that are reduced to a cost prediction set 770. Similarly, unit cost stream 710.1 and other history streams 710.2 may be regressed 720.2 and modeled 730 to provide unit cost prediction 760 that is then reduced to a cost prediction set 770. Other history streams 710.2 may lead the single series methods 720.3 to provide other prediction streams 740 that provide unit cost production 760 and reduce to a cost prediction set 770.

These single series methods 720 may include a mean model where the (sample) mean of the past observations as an estimate of predicted cost for all future periods, a random walk where the last observed cost point as the predicted cost for future periods, a random walk with drift which is similar to the random walk but adding a “constant” long-term trend (drift d) based on past observations to the predicted cost at each future time period, a moving average that involves computing a simple p point average based on past observations Xₜ, Xₜ₋₁, . . . , Xₜ₋ₚ to estimate the value at all future periods Xₜ₊ₕ. A long-term drift or trend may be added as well to the p-point moving average estimates, and a simple exponential smoothing which is a weighted moving average approach that weights recent past observations more heavily compared to older values.

Other methods may be used. These include attempting to model parameter based approaches wherein past observations are used to estimate model parameters of varying complexity. Two approaches that may be used are linear regression and auto-regressive integrated moving average (ARIMA). Linear regression is where the predicted variable is regressed on selected independent variables. Other techniques may be used to predict the independent variables and the regression model to predict our variable of interest. ARIMA may be used to predict the independent variables. Many independent variables have huge numbers of data points which makes it easy to use ARIMA and its variants.

To summarize, a forecast of the time series with more numerous data points is determined, with a technique and regressions for the time series of interest. In forecasting dependent time series for component based on independent time series using regression.
Algorithm 1—forecast dependent time series for component based on independent time series using regression
Require: Independent time series list MPN is dependent on.
   itsList←dependenceOf (MPN)
   MPN RegressionModel←RegressionModel (itsList)
   itsModelList←ForecastModel(itsList)
   itsForecastList←Forecast(itsModelList)
   MPNForecast←Predict(MPNRegressionModel; itsForecastList)

The time series that the component depends on are identified, forecasted independently, regressed, and used to forecast the unit price for the component. Examples of regression variables include commodity, sub-commodity, specific raw materials and specific events. Although, as may be understood, the algorithm is flexible enough to utilize any regression variable.

FIG. 8 illustrates a regression framework 800. Regression framework may be used alternatively or additionally to, algorithm 1 and its techniques described above. Regression framework 800 illustrates the simple regression framework used to forecast variables of interest. As described in FIG. 8, in order to make predictions for the unit price of a component, all the time series or regressors that the component depends on are identified and forecasted independently. Each of the dependent variables are regressed and then used to forecast the unit price for the component. Specifically, regression 800 includes a dependent variable 810, which may include unit cost, sub-commodity cost, commodity cost, and the like, are regressed in the model 875. Independent variables 820, which may include time, sub-commodity cost, commodity cost, exogenous variables, such as raw materials, and the like, are regressed in the model 875. The independent variables 820 are provided to predicted values 840 of X(t) for H periods generated using other techniques X(t+h). The output of the regression model 875 provides estimates 830 of a0 and A by regressing historical values of y(t) against X(t). Estimates 830 and predicted values 840 provide predicted values 850 of y(t) for h periods−y(t+h). Examples of some regressors are set forth below.

An entire commodity (with quantity weighted if quantity is available) may be modeled and forecasted. This forecast model is expected to have sufficient data points to allow for more sophisticated techniques such as ARIMA.

An entire sub-commodity (with quantity weighted if possible, as for commodity) may be modeled and forecasted. Again, this forecast model is expected to have a sufficient number of data points for sophisticated techniques.

Specific raw materials, specific commodities and sub-commodities may be dependent on specific raw materials whose price trends may be easily available. Examples of such raw materials are plastics and metals, like copper, etc. These raw materials may be forecasted using techniques because of the sheer number of data points available. Specific event categories may have a strong effect on the forecast. Over time regression variables may be used for the forecast.

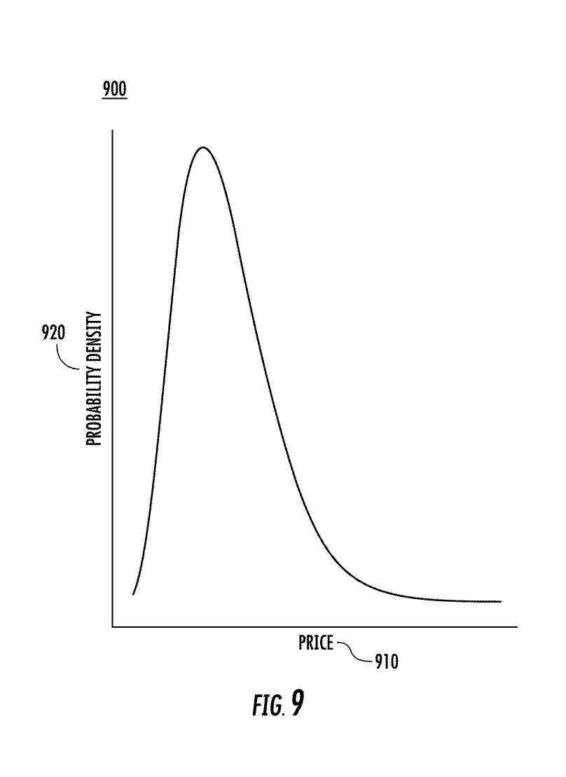

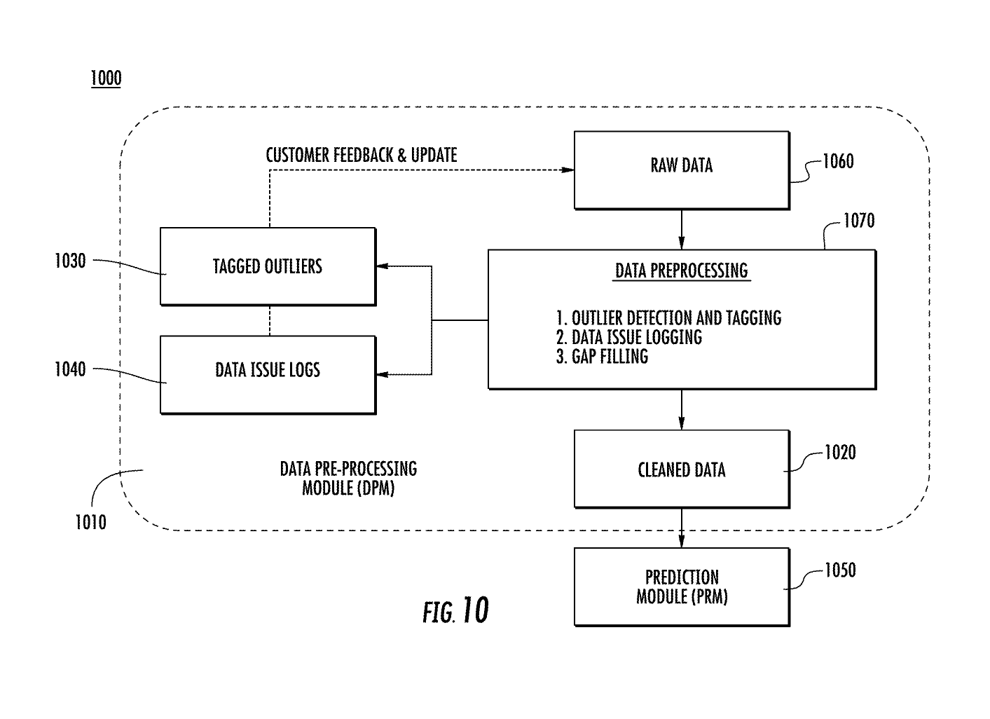

FIG. 9 illustrates an example plot 900 of price 910 represented as a probability distribution 920. The unit price of a component is not one single number that everyone may agree on. Even at the same instant in time, if the same component supplier were asked for a quote by different OEM's, the quote may include a different price. These result from the price 910 quoted depending on the OEM to whom the component supplier is quoted, the amount of inventory with the distributors, the number of component suppliers for that component, the state of their businesses, the demand from other OEMs, and the like. Therefore, one option is to model price 910 as a random variable associating the price 910 not with a single unknown value to determine, but with an infinite number of possible values. All these values together may be described by a probability distribution 920. A probability distribution 920 is characterized by parameters and there are numerous distributions 920 that may be used to model a continuum of numbers. Examples of probability distributions 920 include normal, exponential, beta, gamma, and the like.

Mathematically, the prices 910 are in the domain of positive real numbers. Because they cannot be negative, and may also be very small numbers with sometimes large variance, the normal distribution is not a suitable choice for us. The “best” distribution for the domain of positive real numbers is the exponential distribution. Since its shape is not a good model for the prices, the prices may be modeled with the gamma distribution, usually denoted as gamma (α, β), with parameters α and β. The gamma distribution describes the distribution of prices well.

For those component suppliers where there is sufficient data, the prices 910 may be modeled as random variables with the gamma distribution, and known methods may be used to determine these parameters α and β. For both external and internal benchmarks, the prices 910 have percentile information. These are available typically for the tenth and thirtieth percentiles (but commonly quoted as the ninetieth and seventieth percentiles). For internal benchmarks, the mean and standard deviation may be obtained, which makes the determination of α and β simpler, as will be described herein below. The fact that the ratio of percentiles of the distributions in the exponential family may be beneficial, in which the gamma distribution is a member, depends only on the shape parameter α and not the rate parameter β. The ratio may be used to determine α, and then use the value of α to determine the parameter β. From these, the values of α and β may be forecasted.

The approach of using distributions rather than single values has powerful advantages. With the distribution and the current demand and quote of the price 910, the negotiator may be guided by providing actual probabilities of success of any specific demanded price 910 through the course of the negotiation and provide a numerical value for the intensity of aggressive behavior by the OEM. In the historical data, the quantities may be identified as well as the price 910. This is valuable because the negotiated price may be lower if the quantities are higher. Therefore, this offers another technique to predict the unit price 910 depending on how much quantity is being ordered.

In this technique, the price elasticity may be derived with respect to demand and may be forecasted. Using this price elasticity with respect to demand, the future price may be predicted depending on what quantity is being ordered. Most crucially, a cross elasticity for the price of one component may be defined depending on the quantity of a different components, and possibly the total quantity of all the components for that grouping (i.e., a sub-commodity for that component supplier).

The inverse elasticity is defined for a single component i with respect to itself as:

$$\frac{1}{{n}_{ii}} = \frac{δ ln {P}_{i}}{δ ln {Q}_{i}}$$

The cross elasticity is defined for the price 910 of component i with respect to the quantity of another component j as:

$$\frac{1}{{n}_{ij}} = \frac{δ ln {P}_{i}}{δ ln {Q}_{j}}$$

In practice, the cross elasticity may be computed for a natural group of items. For example, this group may include all items in a sub-commodity. The elasticity (and cross elasticity) may be used to determine the characteristics of the component. They may also be used to determine if the relationship needs to be improved. For example, if the elasticity's sign is abnormal, it could indicate that the customer is not getting a good price despite the high quantity bought. There may be instances where a customer who buys a lower quantity actually gets a lower price, which is counterintuitive. This may be explained by the OEM of larger quantities not having a good relationship with the supplier.

For many of the components, internal and external benchmarks may be used. Internal benchmarks are derived from current and past customers who have used the same components. External benchmarks are obtained from external sources. The following is the formalization of the algorithm.

The unit price of a component i at a time period t is the random variable denoted by Xᵢₜ.

Now, Xᵢₜ ∈ [symbol] ⁺. Since it is not in [symbol] but [symbol] ⁺, a distribution from the exponential family of distributions may be selected.

The density function of the gamma distribution is defined by:

$$p ( {X}_{it} = {x}_{it} ; {a}_{it} , {b}_{it} ) = \frac{{b}_{it}^{{a}_{it}}}{γ ( {a}_{it} )} {x}_{it}^{{a}_{it} - 1} {e}^{- {b}_{it} {x}_{it}}$$

∀Xᵢₜ, with internal and external benchmarks, values for the 10th; 30th and 50th percentile values may be expected. The internal benchmarks are the community analytics data, in that they are derived from actual customer data, without compromising the trust. The mean, standard deviation and the number of data points from which the percentile statistics were obtained may be included. For internal benchmarks, the mean and standard deviation are available for a gamma distribution.

For external benchmarks, percentiles may be used, since they are what are available and standard deviation is not. It may be advantageous to use percentiles to estimate parameters in a distribution in the exponential family of distributions. In a distribution belonging to the exponential family, such as the gamma distribution, the ratio of the percentiles values depends only on the shape parameter α, and not the rate parameter β.

From the percentiles, the αᵢₜ and then βᵢₜ are computed. Because there are three percentiles, three ratios are computed, and therefore three different αit values allow for an average to be improved to improve accuracy of the computation. The calculations are as follows, with F denoting the distribution function, a and b denoting the percentiles, and xₐ and x_{b} denoting the values for these percentiles. For each pair of percentiles, αᵢₜ may be solved from the following:

$$\frac{a}{b} = \frac{F ( {a}_{it} , 1 , {x}_{a} )}{F ( {a}_{it} , 1 , {x}_{b} )}$$

where F is the distribution function (the integral of the p function from the left limit to the value in the argument with αit determined, β may be solved using the following:

α=F(αᵢₜ, β, xₐ)

The values of α and β returned from each of the pairs of α and β may be averaged, where n is the number of percentiles included. With that information, ∀i, t, αᵢₜ and βᵢₜ may be modeled and forecasted.

In order to provide the best possible cost forecast for a set of components, different approaches to combine forecasts generated by the individual forecasting techniques may be used. Combining forecasts from individual techniques rests on the assumption that combining forecasts from methods that differ vastly and which draw from different sources of information may help improve the overall forecast accuracy by taking advantage of the strengths of the individual techniques while masking their limitations. Instead of trying to choose the single best method, using a multitude of methods may help to improve accuracy, assuming that each has something to contribute. Therefore, combining may reduce errors arising from faulty assumptions, bias, or mistakes in the data. However, combining forecasts improves accuracy to the extent that the individual forecasts contain useful and independent information. In the system 100, the individual forecasting methods are markedly different so combining forecasts results in forecast accuracy improvements and hence better future cost estimates.

Simple average may be used so the combined forecast for a given component and time period is obtained by simply calculating the arithmetic mean of all available individual forecasts. Therefore, an underlying assumption here is that all methods contribute equally to the combined forecast estimate.

Trimmed mean may be used so the combined forecast for a given component and time period is calculated by taking the arithmetic mean of the forecasts produced by the top k (=5) best performing models. The top k models pertain to those that have the least historical forecast error. Note here that k is a parameter that can be varied to get the best forecast accuracy.

Inverse error ensemble may be utilized to perform the inverse of a forecasting accuracy (error) metric such as the mean absolute percentage error (MAPE) to estimate the weights used to combine the individual forecasts linearly. Intuitively, forecasts generated by methods that have higher (lower) accuracy or lower (higher) MAPEs have larger (smaller) weights in the linear combination.

Linear regression ensemble may be utilized to perform the combined forecast using a weighted linear combination of individual forecasts that can include terms that account for the correlations between individual forecasts. The weights are determined by minimizing the sum of squared error between the historical costs and their predictions.

Bayesian inference techniques may be used in determining parameters. Since the prices are modeled as a gamma distribution, conjugate priors to continuously learn from the quoted price and the realized price about the state of the market, and therefore advise the buyer of prices. Joint probability distributions of quoted and realized prices may be refined to advise the buyer on where the price is may be depending on the start and initial response for specific items and commodities. Value from the shape parameters for quoted and realized prices may be realized and may describe the extent of fragmentation in the market for that item.

The advantage of guiding the negotiation as mentioned earlier is also an example of a system 100 that learns through the course of the negotiation.

Several data quality issues arise when utilizing customer provided component cost data to make predictions. Time-series data of component unit costs provided by customers are prone to numerous data quality issues that if left unchecked may lead to faulty, biased or erroneous predictions. Such predictions if used by the customer during the price negotiations process for component parts may lead to suppliers either controlling the negotiations process by dictating what the price of the part should be or just walking away due to an infeasible or unattainable price. Some of these issues include: (a) irregular or missing time-stamps; (b) NA or missing component names; (c) zero values for component cost and/or volumes that are sometimes required to compute quantity weighted costs; and (d) erroneous component cost values that markedly differ from all other costs in the time-series for a given component. To deal with such data quality issues, a suite of mathematical/statistical algorithms have been developed to identify, record and potentially resolve such problems. To detect faulty or erroneous data, defined as outliers, a modified Z-score, inter-quartile range (IQR) method, modified IQR, and Dixon's Q test may be used.

The modified Z-score method uses the deviation relative to the median or middle value of the component cost time-series to detect the potential outliers. The median is more resistant to the presence of outliers in data making the modified Z-score a very robust method to detect outliers. So given a component cost series Xₜ, the modified Z-score (MZS) is defined as MZSₜ=0.6745(Xₜ−μ)/MAD, where MAD=median(Xₜ−μ) is the median absolute deviation and μ is just the median of the series Xₜ. A value Xₜ* is identified as an outlier if MZSₜ>3.5.

The IQR method first sorts cost data series Xₜ in the increasing order of magnitude and obtains two values that are greater than 25% and 75% of all values corresponding to the 25th (p25) and 75th (p75) percentiles. The IQR then uses these to calculate the IQR as p75−p25. An outlier is identified as a value of Xₜ* that is lesser than or greater than 1.5 IQR.

The modified IQR detects outliers in data that does not follow the well-known bell-shaped curve but whose distribution is more skewed toward the left or right. The modified IQR utilizes the median-couple (MC), which is a measure of the distance of the values in the left and right sides of the distribution from the median, in the adjusted IQR equation and accounts for the fact that for skewed data distributions the fraction of points that fall outside three standard deviations (1.5 IQR) is quite significant. So an outlier is thus identified as a point whose value is larger or smaller than 1.5 IQR f(MC).

The Dixon's Q-test is used to identify the presence of outliers in datasets with very small sample sizes (˜3-10). To identify potential outliers, the data Xₜ is first arranged in the increasing order of magnitude after which the Q metric is calculated as Q=gap/range for each point Xₜ. gap pertains to the absolute difference between the outlier value in question, Xₜ*, and its closest neighbor and range is the difference between the max and min values of Xₜ. If Q>Q_{c}, then Xₜ* is tagged as a potential outlier. Q_{c} is a reference value based on the number of points in the dataset and degree of confidence in the value being tagged as an outlier.

The list of outliers identified by each of the above methods are ranked and scored based on their frequency of occurrence and selection by the different methods. These methods take a time-series as input and return both the location and value of the potential outlier. These outliers are then removed and the resulting gaps in the data series are filled using various data imputation techniques such as mean or median value of the series or values from the last time period.

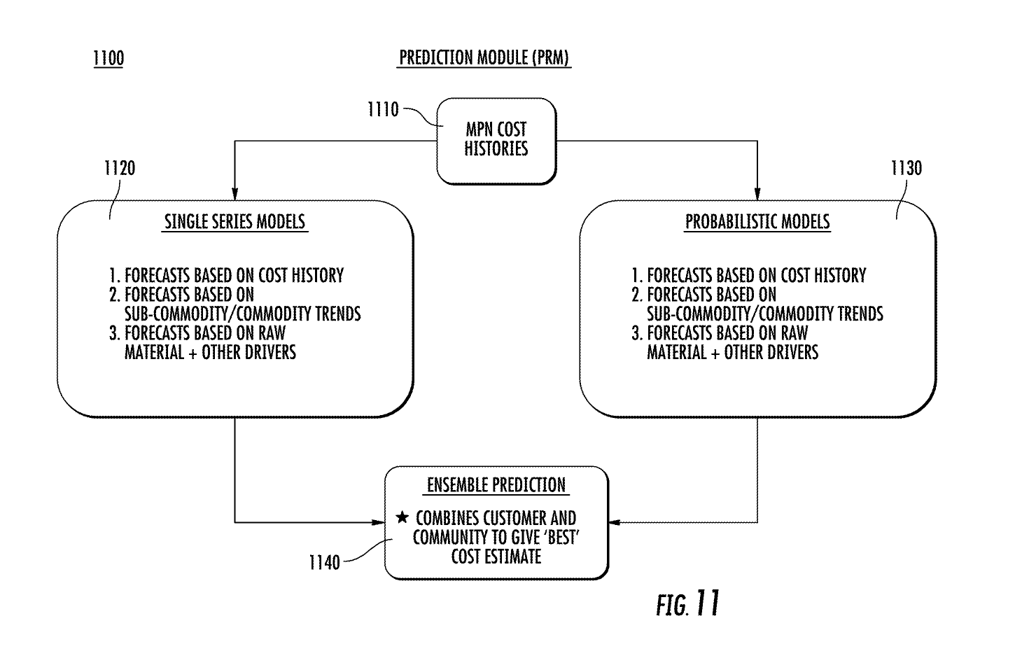

FIG. 10 illustrates the pipeline 1000 used to generate component cost predictions. The pipeline consists of two major components or modules—data pre-processing module (DPM) 1010, and predictions module (PRM) 1050. DPM 1010 is used to identify, record and resolve problems related to data quality issues discussed hereinabove. DPM 1010 operates on raw data 1060 with data preprocessing 1070 to output cleaned data 1070. Data preprocessing 1070 may also provide tagged outliers 1030 and data issue logs 1040. Data preprocessing 1070 operates using outlier detection and tagging, data issue logging and gap filling described above. Therefore, the output generated by DPM 1010 may be classified into three groups (a) cleaned time-series data 1020 including component cost histories, (b) component costs tagged as potential outliers 1030, and (c) other issues related to data quality such as zero component costs, NA values, for example.

Tagged outliers 1030 and data issue logs 1040 may be feedback into the raw data 1060 along with customer feedback and updates. For example, the customer may provide assistance to validate historical component costs that have been tagged as outliers are truly abnormal values that need to be corrected or that these represent special or discounted costs conceded by the supplier during the negotiation process.

The cleaned data 1020 generated by the DPM 1010 is provided PRM 1050. PRM 1050 generates the forecasts for component unit costs. Prediction of component costs may fit into two groups: customer data forecasts and community data forecasts. Customer data forecasts include forecasting component costs for a single or a group of components (MPNs) for a particular customer from the historical time-series of component cost data using the forecasting techniques described hereinabove. Community data forecasts using probabilistic models described herein to forecast the statistical properties of the component cost distribution such as the mean, standard deviation and percentile values for a single or group of components by using historical community (benchmark) component cost data.

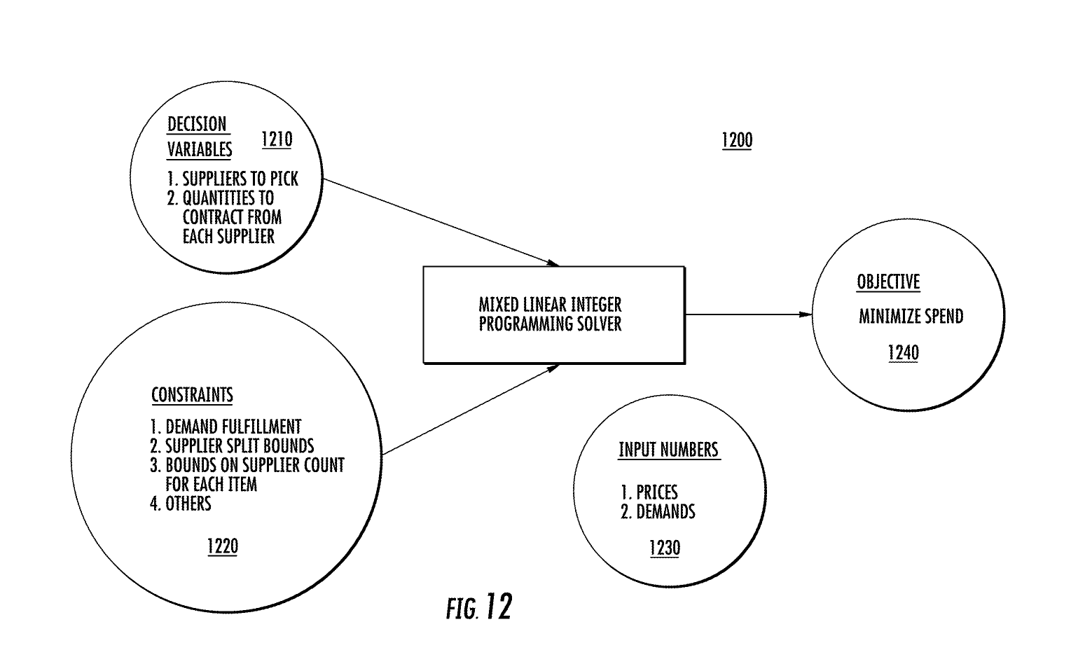

FIG. 11 illustrates the predictions 1100 generated by the PRM of FIG. 10. The predictions 1100 may be performed by the PRM at both or either of the customer or community levels. The predictions 1100 may be used to generate component cost forecasts. Predictions 1100 may compare predictions between the customer and community levels to produce a best forecast for a given component MPN.

PRM may include component cost histories 1110 that are provided to each of a single series models 1120 and probabilistic methods 1130. Single series models 1120 may include forecasts based on cost history, forecasts based on sub-commodity/commodity trends, and forecasts based on raw materials and other drivers. Probabilistic methods 1130 may include forecasts based on cost history, forecasts based on sub-commodity/commodity trends, and forecasts based on raw materials and other drivers. Single series models 1120 and probabilistic models 1130 output to ensemble prediction 1140. Ensemble prediction 1140 compares individual forecasts generated by these three sources and selecting the one with the least error. In summary, each of the possible prediction algorithms provides the prices for each component in each time period, and the different bounds for each component in each time period. The bounds are valuable to describe confidence in the predicted prices and to aid in setting the parameters associated with recommendation and negotiation going forward.

Generally, the prediction of the unit cost distribution of a particular component at future time periods using the same collection of methods, trends and raw materials that used to predict the absolute values of component unit prices described by the single-series methods. For a given component part, the unit cost distribution is obtained from two sources namely, customers who source the same part from different suppliers and a third party source such as Lytica that maintains detailed statistical summaries of a large set of component parts from across the universe of customers. The estimates of component unit prices are sampled from the unit cost distribution which is compared with the corresponding single-series counterparts and then the predicted unit price with the least historical error is selected.

There are two approaches to the recommendation 620. One is based on holding prices fixed and determining quantities (split by component supplier) that minimize spend. The other is based on holding quantities fixed and determining prices that minimize the spend. The spend for a set of items is Σᵢⱼ,pᵢⱼqᵢⱼ where i denotes items and j denotes suppliers, and p denotes prices and q denotes quantities. If both unit prices and quantities are variables, the expression is non-linear and non-trivial to handle in an optimization problem. But when either of unit price or quantity is fixed as a constant, the expression is linear. The constraints are also linear in the same attribute that is regarded as the variable. Two approaches are recognized in that either of unit price or quantity may be regarded as fixed and the other regarded as a variable. In the present description, prices are kept fixed while solving for variable quantities.

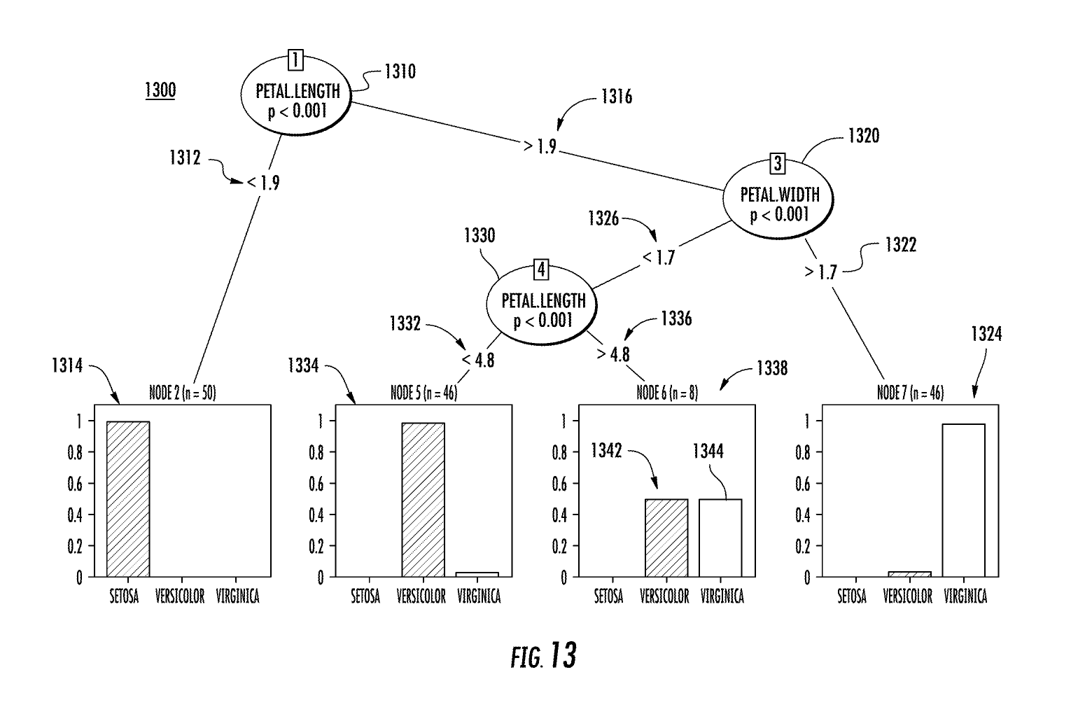

FIG. 12 illustrates a depiction of a mixed linear programming solver 1200 to obtain the optimal split of business between component suppliers. At any given point, a specific split of business between different component suppliers for the same component, with prices fixed as constants may yield the lowest spend for the buyer's organization. Determining and recommending this split, subject to constraints, is the recommendation of FIG. 6, and involves optimization.

The mixed linear programming solver 1200 that determines the split between component suppliers receives a set of decision variables 1210, a set of constraints 1220, a set of input numbers 1230 and an objective 1240. The objective 1240 may be to minimize spend and may include a desire not to sole source. Input numbers 1230 may include prices and demands. Decision variables 1210 may include suppliers and quantities from each supplier. Constraints 1220 may include demand fulfillment, component supplier split bounds, bounds on component supplier count per item, etc.

Multiple component suppliers are expected to respond to an RFQ. Each component supplier may respond with a specific unit price, which may be revised downwards during the course of the negotiation. But at any given point in time during the RFQ and negotiation process, the buyer may be able to determine what proportion of the business may be awarded to each of the chosen component suppliers, among the many that may have responded. This may enable the ability to minimize the total spend. For example, the RFQ may be sent to seven component suppliers, all of whom may respond. But the choice may be restricted to only, say, three component suppliers. Among these three component suppliers, the buyer may split the quantity to be bought in the ratio of 1:4:5, because that results in the minimal spend.

The supplier split may be maintained during the process allowing the buyer an edge in what to ask each supplier, and what to concede. For example, the buyer may ask for a lower unit price and concede a higher proportion of business to the component supplier if unit price is agreed to. All this may be provided information and recommendation of FIG. 6 to the buyer.

The following variables and inputs may be used with mixed linear programming solver 1200.

qᵢ is the quantity of the component i that is needed in that time period. While getting the values of qi itself is the norm, it may also be that qᵢ itself may need to be obtained from the bill of materials for a collection of products subscripted by k and the forecast Qₖ for these products. For example, if the product is a bicycle and the component is a tire, it may be that the quantity provided is not for a tire but for a bicycle. In that case, the bill of material may be used to determine that 12 red and 11 blue bicycles mean 12*2+11*2=46 tires, and 46 is the input to the optimizer. Therefore formally, it may be that qᵢ=φ(Qₖ, k=1, . . . K; bill so f materials), where φ is the programming routine that uses the forecasts for finished products and the bills of materials to obtain the quantities needed for the component i. ⋅ qᵢ is the quantity of the component i that is needed in that time period.

pᵢⱼ is the price currently associated with the component supplier j for item i.

[Nᵢ^{min}, Nᵢ^{max}] are the bounds on the number of component suppliers that may be chosen for component i.

[αⱼ^{lower}, αⱼ^{upper}] are the bounds on the fraction of business (money, not quantity) for component supplier j if the component supplier is chosen as one of the component suppliers in that award.

xᵢⱼ, representing a part of the decision variable set, is the quantity of MPN i bought from component supplier j. Determining all the xᵢⱼ values is the optimization. Note that a single subscript i is used to describe the component CPN and the i in the double subscript ij to describe component MPN. This is because one component CPN quantity may be filled by multiple component MPNs, since each component supplier may have a different name for the part that fills the need for a single component CPN at the customer. That is captured by the double subscript ij where j refers to the component supplier.

Xᵢⱼ ∈ {0, 1} is a set of variables representing whether component supplier j is chosen for item i

The objective function is Z=Σᵢⱼpᵢⱼxᵢⱼ.

The constraint on meeting the demand is

qᵢ−eᵢ≤Σⱼxᵢⱼ≤qᵢ+eᵢ

where eᵢ is the amount of “play” in the demand. This may default to zero, but in practice, this may be obtained as the error in the forecasting system and suitably modified.

The constraint on choosing a component supplier for an item is Xᵢⱼ≤MXᵢⱼ where M=1+Σᵢqᵢ.

The constraint on buying a minimum amount from a supplier if the supplier is chosen is xᵢⱼ≥mXᵢⱼ where m is the minimum amount that has to be ordered from that supplier if that supplier is chosen for that item.

The constraint on the split of business between component suppliers is

$${a}_{j}^{lower} \leq \frac{{\sum }_{i} {p}_{ij} {x}_{ij}}{{\sum }_{ij} {p}_{ij} {x}_{ij}} \leq {a}_{j}^{upper}$$

The constraint on the number of component suppliers chosen is:

$${N}_{i}^{min} \leq {\sum }_{j} {X}_{ij} < {N}_{i}^{max}$$

A solution may be obtained for every component collection in an RFQ, or even across RFQ's. With each solution, the dual variables may be used to indicate to the buyer what constraints matter the most. Using these, a recommendation from FIG. 6 may be provided to the buyer indicating the concessions to ask of each component supplier, and what concessions to offer. A sensitivity analysis may be performed and the specific prices that are worth negotiating may be identified. While it is arguable that the human may see these as obvious in many cases, the sheer magnitude of the different variables at play makes the difficulty of grappling with it far beyond human ability. It also allows the RFQ process to handle responses from many more component suppliers than is currently done, which benefits the buyer, since the price advantage increases with the number of component suppliers in an RFQ.

The preceding sections described the minimization of cost by selection of suppliers and allocation of quantities between them. In practice, for system 100, other considerations occur. The lowest cost supplier may lose its sheen because the quality or reliability may be unacceptably low. So, other suppliers may be selected and/or allocated more quantities. System 100 may include an acceptable definition of quality and reliability (and in future, other considerations). This may be defined in terms of money that may be potentially lost. For an example of factoring in quality issues, if the supplier had a certain fraction fᵢⱼ of the volume of a certain item i when obtained from supplier j has been quarantined or rejected for quality issues in a predetermined period of time stretching into the past, that fraction may multiplied by the decision variable for quantity xᵢⱼ and the unit cost for the item i with supplier j is pᵢⱼ. The expression Σᵢⱼfᵢⱼpᵢⱼxᵢⱼ denotes the “cost” that is expected to be incurred to obtain this item from this supplier.

Similar to quality issues, reliability can be thought of in terms of the fraction of the quantity of the item i from supplier j that were late in a predetermined period of time stretching into the past. This can be used to obtain an expression exactly analogous to the above one for quality.

Three optimizations may be solved. First, one for the cost minimization as described hereinabove and one for quality cost minimization and one for reliability cost minimization. The values may be presented to the user to allow for tuning by placing limits on the cost, quality and reliability measures. These restrictions may then be sued as constraints and optimized for the remaining objective.

The effective prediction of prices sets the background for any negotiations. The optimal selection among choices enables the best that the OEM can do at any given point. This may not directly benefit the negotiation. Instead, negotiation may be benefitted by recognizing levers of negotiation and utilizing them effectively, including to counter the levers that the component supplier or CM may use. For example, pointing out that the component supplier has not provided any unit price concessions in the last eight quarters, while the business the component supplier has got has gone up fifty percent is effective to obtain a concession in the unit price going forward. All negotiations have objectives. The objective for a component supplier manager is typically the savings.

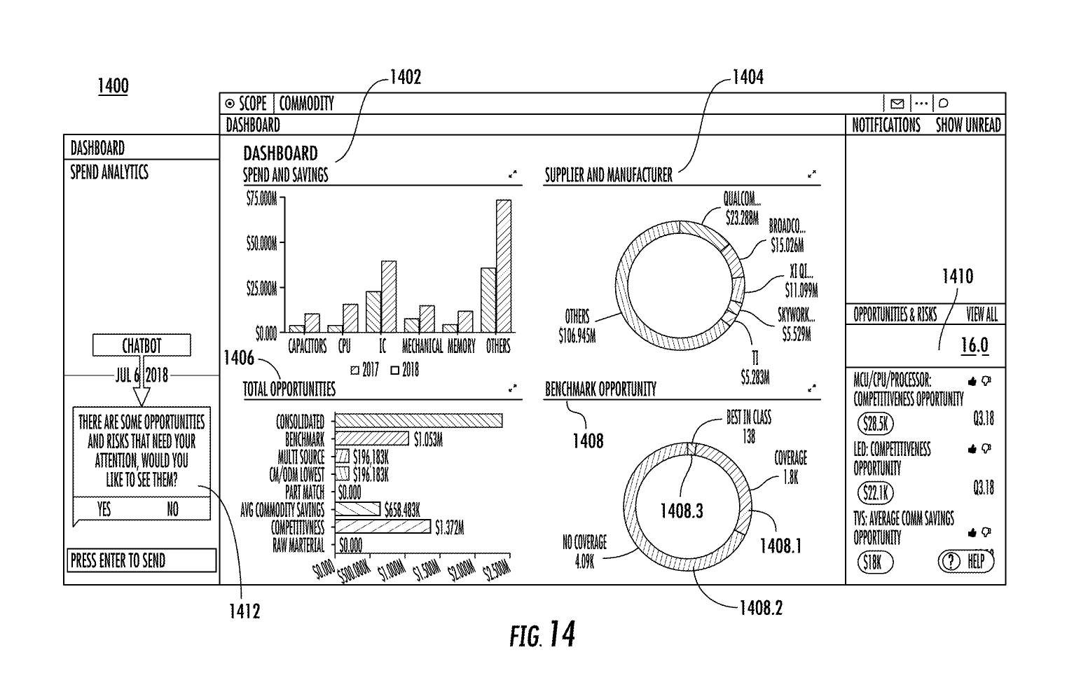

FIG. 13 illustrates an example of classification 1300. In FIG. 13 the classification 1300 is an Iris flower into species depending on sizes of petals and sepals. The classifier operates to assign probabilities to what species the flower might be. If the probability is sufficiently high the classifier is assumed correct.

Generally, classification is the act of labeling a data point so that it is determined to belong in a particular class. From the lengths of sepals and petals, the species of a specific Iris flower may be determined from the set of Setosa, Versicolor and Virginica.

A set of training examples may be provided to the classifier. This classifier builds a model from the training examples. After training, if the model is provided the sepal and petal widths and lengths for a new specimen, it is expected to predict whether that specimen is Setosa, Virginica or Versicolor.

With the sizes of the petals and sepals, the classifier 1300 seeks to determine the species, with different confidence levels. The predictors (that is, the sepal and petal widths and lengths) are numbers. But the predictors need not be numbers and may include or be strings as well. Depending on the predictors, how many of them are considered for each record, as well as the size of the data to train, different methods may be used to perform a classification.

In FIG. 13, petal length may be used as a first determination 1310. A petal length less than or equal to 1.9 1312 results in a classification of Setosa 1314. A petal length greater than 1.9 1316 causes a second determination 1320 of petal width to be used. A petal width greater than 1.7 1322 results in a classification of Virginica 1324. A petal width less than or equal to 1.7 1326 causes a third determination 1330 of petal length to be used. A petal length less than 4.8 1332 results in a classification of Versicolor 1334. A petal length greater than or equal to 4.8 1336 results in a split classification 1338 of Versicolor 1342 and Virginica 1344.

Conditional inference trees implemented in R may be used. In addition to such a tree, neural nets may be used to perform the classification by handling very large dimensions in the data while performing the classification. The methods may be used to classify sentences and discover the levers and the responses, and to identify the effective counters to the different levers.

This type of classifier may be applied to numerous aspects of system 100 including sub-commodity classification, classification of sentences into actions and objects to navigate via a ChatBot, classification of sentences, news items, and other elements, to discover levers and the responses to help aid the process of negotiation and identify effective counters to the different levers.

For sub-commodity classification, in negotiations to source parts at the best attainable prices from suppliers, an important task for the customer or buyer is to accurately classify sub-commodities or commodities into relevant hierarchies or groups. Component prices may be strongly correlated with the overall price trends of the sub-commodities or commodities to which they. Since one of the algorithms used to predict future prices of components involves regressing against sub-commodities or commodities price trends, improper or misclassification of the sub-commodities or commodities associated with these components may result in erroneous or inaccurate price predictions for those components.

System 10 classifies sub-commodities or commodities into their relevant hierarchical groups. This enables an inferences of sub-commodity class from the merchandise, in particular, electronic components or parts, attributes such as description, manufacturer name, manufacturer part number (MPN), as described in the Table 1 displaying an example of MPN's, Sub-Commodities and their descriptions below.

TABLE 1

| | Sub- | |
|---|---|---|
| MPN | commodity | Description |
| bat4c | Resistors | RES, S/M, LF, 10K OHM, 5%, 1/16 W, |
| | | 0402 |
| abc123 | Resistors | RESISTOR, FXD, FILM, CHIP, 12K |
| | | OHMS, 0.3 W, 0.1% |
| 125XY | Capacitors | CAPACITOR SMR, CAP, TA, 10 |
| | | UF, +−20%, 25 V |
| SF243FED | Capacitors | CAP. FT, 10 UF, 35 V, 20%, 195 D |

From this example it follows that the raw data are presented as specific text codes including full words and their abbreviations. The classifier may define features adequately defining objects to be classified. The classifier may select classification algorithm. At present, the most advanced are artificial neural network (ANN) classifiers in which both feature selection and classification are handled by one algorithm. Descriptions may be combined, components and/or other attributes (e.g., by just concatenating corresponding text codes into strings) into raw vectors, assign labels (class indicators) and then run a training procedure to calculate classifier parameters, such as weight coefficients in the case of ANN. Text strings are embedded by special pre-processing algorithms into sparse or compressed numeric representations in the form of multi-dimensional vectors, so that classification algorithms can be used. To provide high accuracy of classification, one may need to use multi-layer (6 and more layers) ANNs usually referred to as deep learning algorithms. System 100 may utilize two kinds of deep learning algorithms based on feed-forward and recurrent ANN.

A machine learning chatbot may be used in communication between the parties of system 100. The chatbot may differentiate between professional requests for a variety of data about relevant market attributes and pleasantries. The professional chat flow provides (a) action recognition which navigates to the a product website and displays information such as raw material trends, current customer spends etc., corresponding to the action recognized, and extraction of objects which correspond to specific attributes of the data such as time periods, raw material of interest, suppliers, commodities, components and others.

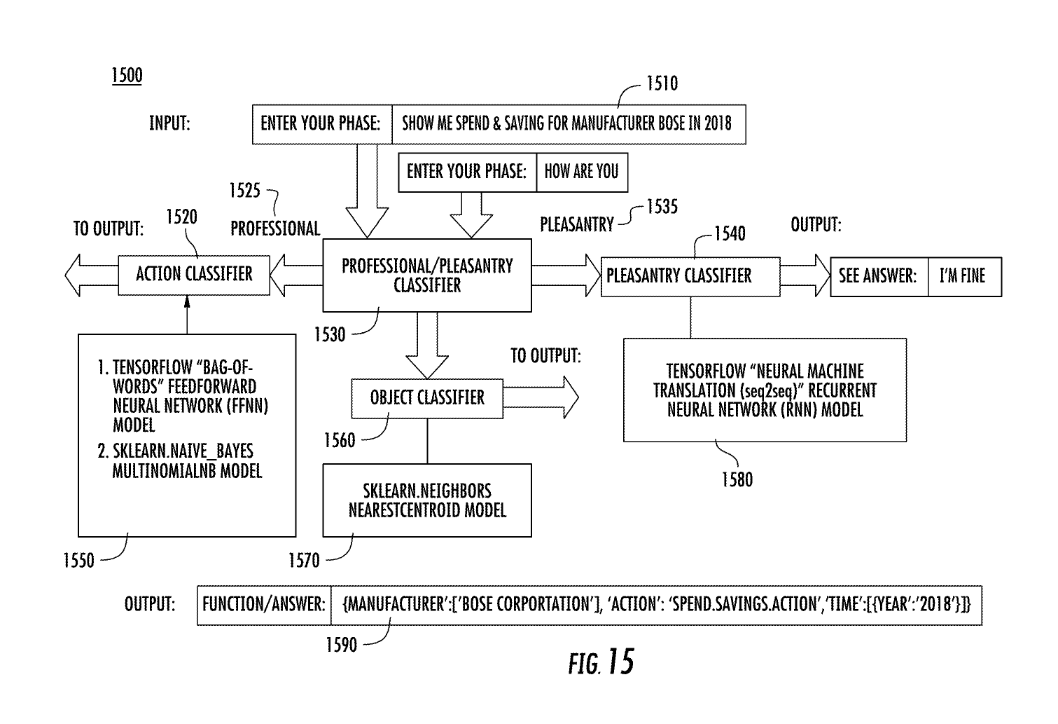

FIG. 14 illustrates a screen depiction 1400 of the screen of the system of FIG. 1. Screen 1400 depicts a dashboard to a user with high-level information. This high-level information may include spend and savings 1402 for various sub/commodity/commodity classes that may be relevant to the user. As depicted, spend and savings 1402 includes information on capacitors, CPU, IC, mechanical, memory, and others. In this case, spend and savings is illustrated as a comparison of the previous year 2017 with the current year 2018 broken down by commodity.

Screen 1400 depicts a spend associated with primary manufacturers and suppliers 1404. By way of example, the spend associated with Qualcomm, Broadcom, Xin Qi, Skyworks, TI and other entities may be depicted.

Screen 1400 depicts the total opportunities 1406 available to a user. These may include total savings opportunities, such as over the next quarter or next four quarters relative to current or the last four quarters, available to a customer. The total savings opportunities may include an aggregation of savings opportunities from several individual portions. These individual portions may include, for example, as depicted, consolidated, benchmark, multi-source, CM/ODM lowest, part match, commodity savings, competitiveness and raw material are all monitored and depicted.

Consolidated savings opportunity may be calculated by aggregating total spend savings opportunities on a per component basis by cherry picking the “best” savings opportunity available from across all savings opportunity dimensions such as benchmark, multi-source, part match, average commodity savings, competitiveness and raw materials,

Benchmark is determined by comparing the amount a customer is spending on all parts/components relative to others in the community,

Multi-source/CM-ODM provides the customer spend savings opportunities available based negotiating with several CM-ODMs or manufacturers/suppliers using the lowest price quoted by a particular CM-ODM or manufacturer/supplier,

Part match is determined from the total opportunities associated with similar parts for which the community is paying lower prices,

Average commodity savings provides the average cost savings opportunity associated with all commodities made up of individual MPNs,

Competitiveness provides the total spend savings opportunities available to a customer at the sub-commodity level by comparing average historical cost savings over a time period, such as the past four quarters, with the corresponding cost savings available from across the community for the current quarter or future quarters. Competitiveness provides a measure of how ‘competitive’ the customer is relative to the community in terms of potential spend savings at the sub-commodity level.

Raw material provides a savings opportunity (or risk) associated with volatility in raw material drivers that make up the component parts.

Benchmark opportunities 1408 are also depicted. Coverage 1408.1 depicts opportunities associated with standard parts that are sourced by the entire community of customers for which there is information available. This information may be from a third party vendor. In this example the coverage may be X=1.8K.

No coverage 1408.2 indicates parts for which system 100 was unable to determine any savings opportunities. No coverage 1408.2 may result from parts that are specific to that customer and consequently no community data available for comparison or it might be due to mis-specified or lack of available information on the MPNs, for example. In the depicted example, no coverage 1408.2 is X=4.09K.

Best in class 1408.3 indicates that for those parts, the user is best-in-class in terms of savings opportunities. In this example, this is for X=138 parts.

Opportunities and alerts 1410 may be aggregated from various resources such as news, internet, media, and the like, that are relevant to that user. Opportunities and alerts 1410 may be utilized as levers during the process of negotiation with suppliers/manufacturers.

Additionally, chatbot 1412 described herein is depicted in screen 1400.

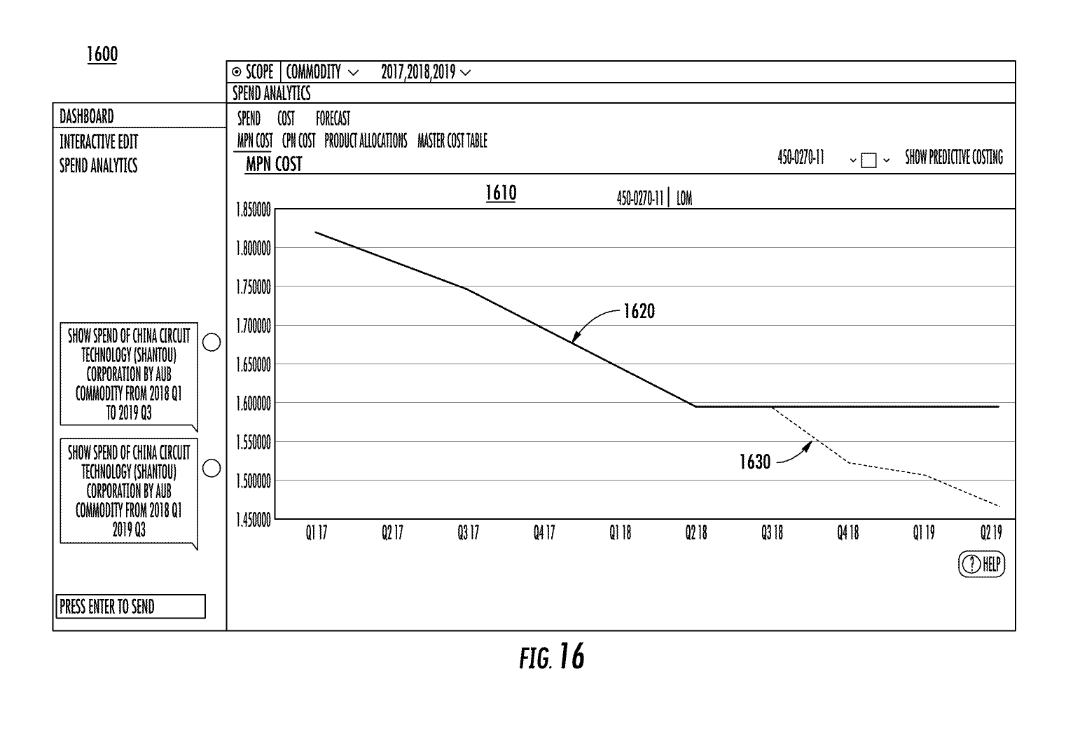

FIG. 15 illustrates a flow diagram 1500 providing modules for a chatbot for interacting within system 100. Flow 1500 does not show training datasets including action request phrases as well as customer data provided by customers in the form of an Excel file with different sheets defining different objects such as commodity, supplier, manufacturer part number (MPN), etc.

Phases that describe commonly used pleasantries entered by the customer elicit responses that emulate human speech. For instance, the chatbot may respond to greetings like “Hello” with equivalent greetings like “Hi!” and greetings like “How are you?” with responses like “I'm fine”. For ease of use for the customer, auto-completion of phrases may be implemented in a manner similar to what is currently available with major search engine such Google or Bing.

Online operation of our chatbot may follow the flow diagram 1500. A phrase, such as an information request or pleasantry, is entered as an input 1510. The phrase is categorized by the classifier 1530 into either a professional dialogue 1525 or a pleasantry 1535. The action classifier 1520 and objects classifiers 1560 receive the input string simultaneously and, generally, work in parallel. The action classifier 1520 recognizes the action and sends a message to the appropriate module that executes the requested action. The objects classifier 1560 extracts objects (requested parameters) and sends them to another module 1580 that executes or displays the requested object.

The action classifier 1520 uses one of the well-established deep learning algorithms 1550. The objects classifier recognizes an object from the input string in two steps. It finds the “closest” (depending on feature selection and proximity measure adopted) substring (consisting of one or several words) in the customer datasets to the current substring in the input string. 2. It then checks if this closest substring is within a predefined Damerau-Levenshtein distance (DLD) from the input substring. If this check is successful, the object is considered recognized.

The action classifier 1520 is implemented using a feed-forward or recurrent Multi-layer Neural Network (MNN) usually referred to as deep learning algorithms. When training this classifier offline, both weights and word embedding (features) are computed simultaneously. The dimensionality of every embedding vector is defined in advance based on certain relevant assumptions.

The objects classifier 1560 uses the Nearest Centroid (NC) algorithm 1570 where every substring is “vectorized” into sparse vectors where every component contains the number of times an alphabetic symbol shows up in the substring under consideration. Thus, the dimensionality of every such vector is equal to the number of symbols involved. As a measure of proximity, Euclidean distance or dot product can be used.

This approach combining NC and DLD algorithms provides fast and accurate identification of relevant substrings from thousands of objects available in customer data tables. Offline training the Nearest Centroid algorithm is fast as well and is reduced to just vectorizing all the sub-strings describing the objects in customer data tables in the manner laid out above.

Pleasantries classifier 1540 is based on the Neural Machine Translation (NMT) 1580 model known earlier as sequence-to-sequence (Seq2Seq). This model is based on a special MNN architecture with recurrent neural network cells containing gates for memorizing embedding for words, which show up in the target phrase. These cells are known as Long Short-Term Memory (LSTM) units and Gated Recurrent Units (GRU). Offline training of NMT classifiers involves long iterative computations on large datasets to arrive at an acceptable level of intelligence for the chatbot. The Seq2Seq models usually require exhaustive tuning procedures to achieve this goat Flow diagram 1500 ends with the output 1590.

FIG. 16 illustrates a screen depiction 1600 of the spend analytics of screen 1400. Screen 1600 displays a plot 1610 of component unit cost as a function of time. As depicted, plot 1610 provides for a specific component (450-0270-11). Line 1620 represents the historical and forecasted component unit cost provided by the user. Line 1630 represents the predicted cost generated by the prediction module (PRM). As predicted cost (line 1630) is lower than historical/forecasted cost (line 1620), the forecasts provide real savings opportunities. Such lower costs may be utilized in negotiations to achieve greater savings.

On examination of the various actions during negotiation, there are only a few fundamental negotiation actions. Examples are: inform (that is, reveal or remind the other party of something) where one party can remind the other of concessions made earlier, on or without demand and one party can also reveal new information to the other. This information allows a demand to follow. These are the levers that are to be used, and some examples are described following these items. Concede (or offer) where one party concedes something to another party. Typically, a demand follows a concession (or offer). A demand is where one party demands a concession from the other party. From demand information including a revelation of reminder flows, or even concessions. An accepting or rejection where one party either accepts or rejects the other's overture also occurs.

There are finite levers for the buyer, supplier and the CM. Levers may be classified for specific parties, observe the usage of specific levers and their counters by the other parties, and apply machine learning to understand the preferences, and suggest to the buyer the levers to use to open, counter and finish the negotiations. The following are the levers of negotiation and although reminders and revelations are followed by concessions or demands, these are not included in the table below. This is partly for brevity, but mostly because these vary by situation, and machine learning may recognize these in the user activity, and then advise the user. In the tables, a number of levers have been listed from the point of view of the buyer. The buyer may inform (or be informed), concede and demand of a variety of levers and depending on the information or concession, may either concede or demand something else. The only real demand that the buyer has is the unit price, and the only real measure that matters to the buyer's organization is the total spend. Therefore, the buyer tries to reduce the spend with each supplier. This spend is essentially:

Σpⱼqⱼ

where pⱼ is the price of the item j bought from the supplier and qⱼ is the quantity of the item j bought from the supplier over the specific time period. Since qⱼ is the forecast and is subject to uncertainty, it is pⱼ that the buyer tries to get savings on by demanding its reduction.

Table 2 illustrates example levers of negotiation 1 including a buyer's remind, reveal, concede, and demand levers.

TABLE 2

| Item | Reminds | Reveals | Concedes | Demands |
|---|---|---|---|---|
| CAGR | Positive | N/A | Negative | TBD |
| NPI programs | N/A | New long | Internal | TBD |
| | | lifecycle | cost | |
| Actuals to | N/A | Exceeded | Below | TBD |
| forecasts | | | | |
| PSL rank | N/A | Improved | N/A | TBD |
| Collaboration | Recent wins | N/A | N/A | TBD |
| Award time | Longer commit | N/A | N/A | TBD |
| period | | | | |
| Business split | Higher | N/A | Higher | TBD |
| Recognition | Supplier | Supplier | N/A | TBD |
| | of the year | of the year | | |
| Company | N/A | Positive | N/A | TBD |
| growth | | | | |
| TAM | N/A | N/A | Increase | TBD |
| Roadmap | N/A | N/A | Offer to | TBD |
| | | | share | |
| BU | N/A | N/A | Access | TBD |
| Unit cost | N/A | Benchmark | N/A | TBD |
| Unit cost | N/A | Prediction | N/A | TBD |
| Savings | N/A | Trend | Previously | TBD |
| | | | offered | |
| Should cost | N/A | Impact | N/A | TBD |
| Raw material | N/A | Show | Unfavorable | TBD |
| cost | | | | |
| Forex | History | Predictive | Unfavorable | TBD |
| Part | N/A | Alternate | N/A | TBD |
| opportunity | | | | |
| Inventory | Easily purged | N/A | Excess | TBD |
| Inventory | Easily purged | N/A | Obsolescent | TBD |
| Raw material | N/A | N/A | Inflation | TBD |

Table 3 illustrates example levers of negotiation 2 including a buyer's remind, reveal, concede, demand levers.

TABLE 3

| Item | Reminds | Reveals | Concedes | Demands |
|---|---|---|---|---|
| Labor cost | Decrease | N/A | Increase | TBD |
| Doing business | N/A | N/A | High cost | TBD |
| EOL | N/A | N/A | Sustaining | TBD |
| | | | costs | |
| Unique parts | N/A | N/A | Low demand | TBD |
| Awarded projects | N/A | N/A | Cancellations | TBD |
| Outlook | N/A | N/A | No new business | TBD |
| Industry | N/A | N/A | Constraints | TBD |
| Supplier | N/A | Increase | N/A | TBD |
| profit margin | | | | |
| Split | N/A | N/A | Offer to increase | TBD |
| QBR score | N/A | Increased | N/A | TBD |
| Executive | N/A | N/A | Offer | TBD |
| engagement | | | | |
| Co-development | N/A | N/A | Offer | TBD |
| | | | opportunity | |
| Production line | Down | N/A | N/A | TBD |
| Past escalation | Remind | N/A | N/A | TBD |
| Partnership | N/A | N/A | Offer | TBD |
| alliance | | | | |
| Product features | N/A | N/A | Jointly define | TBD |
| Technology | N/A | N/A | Too costly | TBD |
| acquisition | | | | |
| by supplier | | | | |
| Market direction | N/A | N/A | Is different | TBD |
| Volume | N/A | N/A | Lack of | TBD |
| | | | commitment | |
| Price | N/A | N/A | Target too | TBD |
| | | | aggressive | |
| Product feature | N/A | N/A | No cost | TBD |
| | | | opportunity | |
| Cutting edge | N/A | N/A | Proving ground | TBD |
| technology | | | | |
| Debug | N/A | N/A | Opportunity | TBD |
| Supplier forum | N/A | N/A | Speak | TBD |

Deep learning techniques may be used to learn from the buyers recognizing and employing the different levers above. For example, the CAGR number per supplier may be provided during negotiations with that supplier. The negotiation proceeds as follows. The buyer demands a concession (usually on the unit price). The demand is accompanied by one of the levers identified in the tables above. The supplier either concedes the demand or concedes it only partially. The partial concession or denial is accompanied by a lever that the buyer is forced to concede. This exchange repeats until the buyer has gotten what the buyer's organization wants, or until time has run out for the buyer. System 100 interacts with the buyer as in Table 4 where there is illustrated the negotiation process with suggestions and earning that may occur.

TABLE 4

| User Action | Response |
|---|---|
| | 1. Offers ranked demands [item, price, |
| | lever(S)] |
| 2. Buyer selects [item, price, | 3. Records and informs supplier |
| lever(s)] | |
| 4. Supplier responds with offers | 5. Records, recognizes, informs, advises |
| [item, price, lever(s)] | buyer |
| 6. Steps 1-5 repeated until buyer | . . . or time runs out. |
| satisfied | |

System 100 records the demand, accompanying levers, the (non-) concession by the supplier, accompanying levers, and the success of each demand. The application subjects to a classification learning process on a neural net (with multiple layers), and uses this to recommend more successful demands, item categories, and levers. System 100 anticipates the levers the supplier may retort with to partially or completely deny the demands. This anticipation is performed in two steps. One is the recognition of levers, demands, concessions, acceptances, rejections etc. from the text. The other is advising the buyer of counter-levers to use, and of those the supplier may use. Deep learning on the text is step one. The responses of the suppliers consist of text or other type of response. In this text the acceptance and rejection of the demands occurs and the concessions and the specific levers accompanying these. Training data from the text may be used to train a deep neural net model. This model may be used to classify the levers, demands, concessions, acceptance, and rejection in the responses. The data to train may include a binary array whose length is the size of the total dictionary of words. Text processing libraries such as NLTK library in Python, for example, may be used to recognize sentences, stem or lemmatize words, create a sorted list, and thereby represent every sentence as a binary array. This binary array is the format of the data that is used to train the neural net, and fed to the trained net to recognize the classes described in detail in earlier sections. The output is another binary array representing the class that is recognized from the input.

Machine learning on the levers and counters is step two. Classifying the responses is not enough. The offers with the levers and the counteroffers with the counter-levers form a sequence. With sufficient data, the levers that are effective may be predicted as well as the ones that are not. This prediction may be performed using deep learning and/or random forest methods.

Additionally, the prices being demanded and countered may also be subject to a machine learning method. For example, the gap between the demanded and countered prices (normalized against a suitable value) may be a function of the step, as well as other parameters like the OEM, the supplier, the MPN, the CPN, time to deadline(s) and numerous other possibilities depending on the specific situation. A model to predict subsequent prices is created and regression or auto-regression is utilized.

Formally, the input features and the classifier output to the deep neural net classifier, or alternative, may be the following: buyer selected tuple [item, price, lever] including the fractional change from the past price, normalized against the fractional changes on that item or sub-commodity elsewhere, and bucketed; supplier response [item, price, lever] including the fractional change from the past price, normalized against the fractional changes on that item or sub-commodity elsewhere, and bucketed; sub-commodity; commodity; customer; supplier; business trend between buyer and supplier organizations; and numerous other features may be included over time. The output of course is the response lever that has been observed to be successful. The data here is a sequence of levers represented as binary arrays of the lever names themselves.

During the course of the negotiation, the probabilities of the buyer being successful in a particular demand may be continuously updated. This probability depends on the baseline probability as well as the levers used. Initially, the baseline probability along with the last known demand and quote set the probabilities at each step, including the first. System 100 may provide probabilities that may be conditioned the choice of levers, and the buyer advised accordingly.

A single training record i is composed of:

[[X_{i,1}, X_{i,2}, . . . , Xᵢⱼ, . . . , Xₙ], [Y_{i,1}, Y_{i,2}, . . . , Y_{i,k}, . . . , Y_{i,c}]]

In the above, for each i, X is a binary array, representing the words. Y is another binary array, with the Y_{i,k} being 1 for exactly one k, representing the class. These classes may be in the categories representing concessions, demands, rejections, acceptances and levers, and possibly others in the future (e.g., sentiment). A sufficient number of these are used for training. Once the model is created, the model can be stored on a set of records again represented as [[X_{i,1}, X_{i,2}, . . . , Xᵢⱼ, . . . , Xₙ], [Y_{i,1}, Y_{i,2}, . . . , Y_{i,k}, . . . , Y_{i,c}]]. Finally, the model is used to determine the class of the input sentence, by providing the input of only [[X_{i,1}, X_{i,2}, . . . , Xᵢⱼ, . . . , Xₙ]. A single training record i is composed as follows, similar to the recognition problem.
[[X_{i,1}, X_{i,2}, . . . , Xᵢⱼ, . . . , Xₙ], [Yᵢ]
   Here, Xᵢⱼ represents the lever in the j^{th} exchange, given a maximum of n exchanges. Additionally, there may be other drivers that are not levers, but represent the state of the parties in negotiation. For example, the size classification of the buyer and seller organizations, the classification of the amount of business done in the past, the item being negotiated, etc., as well as the items like commodity, etc., described earlier. These may vary by customer well. The Yᵢ represents the response to that lever that was subsequently determined to be effective. Obviously, a measure of effectiveness may be determined by a variety of criteria including relating to immediate concessions or to a significant gain at the end of the negotiation.

The training itself may be performed using random forests and/or deep neural nets. The former does not require any transformation of the data and can be used if the space of inputs is small. The latter can be used if the number of levers and steps is large and consequently, the space is large. The training record i is composed as follows:

$$[ {t}_{i} , {x}_{i , 1} , {x}_{i , 2} , … , {x}_{i , k} , \frac{{p}_{i} - {p}_{i - 1}}{{p}_{i - 1}} ] .$$

The fractional change in price as a function of all the preceding variables may be predicted in a new record.

For pricing response determination, a variant of regression or auto-regression (Time Series) may be utilized. From the model, the price to ask may be predicted at a particular round in the negotiation. Additionally, the probabilistic method may be utilized.

The methods provided may be implemented on a general-purpose computer, a processor, or a processor core. Suitable processors include, by way of example, a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a computer readable media). The results of such processing may be maskworks that are then used in a semiconductor manufacturing process to manufacture a processor which implements features of the disclosure.

The methods or flow charts provided herein may be implemented in a computer program, software, or firmware incorporated in a non-transitory computer-readable storage medium for execution by a general-purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

1. A device for enabling improved negotiations in a supply chain between parties to the supply chain, said device comprising:
a communication device for receiving information regarding interactions and transactions regarding the parties involved in the supply chain;
a processor for determining factors that aid in the leverage of negotiations between the parties involved in the supply chain by analyzing the received interactions and transaction; and
a transmitter for transmitting the identification of the determined factors and the respective values based on the entity using the device.

2. The device of claim 1 wherein the factors include component per unit cost.

3. The device of claim 1 wherein the factors include the number of component.

4. The device of claim 1 wherein the factors include the GDP of the country where one of the parties is located.

5. The device of claim 1 wherein the factors include the cost of resources used in the supply chain.

6. The device of claim 1 wherein the factors include at least the cost of a sub-component involved in the supply chain.

7. The device of claim 1 wherein the communication device includes a communication interface for monitoring information.

8. The device of claim 1 wherein the factors include exchange rates.

9. The device of claim 1 wherein the factors include the time series from which the price of a component depends.

10. The device of claim 1 wherein additional factors are forecasted.

11. A system for enabling improved negotiations between parties in a supply chain, said system comprising:
a plurality of parts that together are assembled into an output product of the supply chain;
a first supplier for supplying a first of the plurality of parts;
a second supplier for supplying the first of the plurality of parts; and
a device for enabling improved negotiations in the supply chain between an OEM and the first supplier and between the OEM and the second supplier, the device including a communication device for receiving interactions and transactions regarding the OEM, the first supplier and the second supplier regarding the first plurality of parts, a processor for determining factors that aid in the leverage of negotiations between the OEM and either of the first supplier or the second supplier by analyzing the received interactions and transaction, and a transmitter for transmitting the identification of the determined factors and the respective values to the OEM.

12. The system of claim 11 wherein the factors include component per unit cost.

13. The system of claim 11 wherein the factors include the number of component.

14. The system of claim 11 wherein the factors include the GDP of the country where one of the parties is located.

15. The system of claim 11 wherein the factors include the cost of resources used in the supply chain.

16. The system of claim 11 wherein the factors include at least the cost of a sub-component involved in the supply chain.

17. The system of claim 11 wherein the communication device includes a communication interface for monitoring information.

18. The system of claim 11 wherein the factors include exchange rates.

19. The system of claim 11 wherein the factors include the time series from which the price of a component depends.

20. The system of claim 11 wherein additional factors are forecasted.
